(19) United States
(12) Patent Application Publication
(10) Pub. No.: US 2025/0385960 A1
(43) Pub. Date: Dec. 18, 2025

(54) Expandable Configurations for Attachable Accessories for Mobile Electronic Devices

(71) Applicant: OhSnap Gaming LLC, Apex, NC (US)

(72) Inventors: Joshua Levi KING, Fredericksburg, VA (US); Dale Christopher BACKUS, Broadway, NC (US); Shafae Noaman ALI, Raleigh, NC (US); Eric Lucas EPSTEIN, Durham, NC (US); Peter James DIEMER, Mocksville, NC (US); David Paul ECHEM, Apex, NC (US); James Alexander STONE, Raleigh, NC (US)

(21) Appl. No.: 19/239,933

(22) Filed: Jun. 16, 2025

Related U.S. Application Data
(60) Provisional application No. 63/660,674, filed on Jun. 17, 2024.
(60) Provisional application No. 63/736,765, filed on Dec. 20, 2024.
(60) Provisional application No. 63/760,052, filed on Feb. 18, 2025.
(60) Provisional application No. 63/778,999, filed on Mar. 27, 2025.

(51) Int. Cl. H04M 1/02

(52) U.S. Cl. CPC H04M 1/0203

(57) ABSTRACT

In one embodiment, an attachable accessory for mobile electronic devices that includes an upper-case and lower-case elements. The upper-case element is configured to secure a mobile electronic device, and the lower-case element has input interfaces on its top portion. The upper-case element is coupled to the lower-case element with an opening mechanism that enables the attached accessory to move from a closed position to an expanded position. When the attachable accessory is in the closed position, the upper-case element substantially overlays the lower-case element, and the top portion of the lower-case element is substantially covered by the upper-case element. When the attachable accessory is in the expanded position, the upper-case element is substantially displaced from the lower-case element and the top portion of the lower-case element is substantially exposed.

### PRIORITY

This application claims the benefit under 35 U.S.C. § 119 (e) of U.S. Provisional Patent Application No. 63/778,999, filed 27 Mar. 2025, U.S. Provisional Patent Application No. 63/760,052, filed 18 Feb. 2025, U.S. Provisional Patent Application No. 63/736,765, filed 20 Dec. 2024, and U.S. Provisional Patent Application No. 63/660,674, filed 17 Jun. 2024, each of which is incorporated herein by reference.

### TECHNICAL FIELD

This disclosure generally relates to accessories for mobile electronic devices, and in particular relates to an attachable accessory designed to attach to a mobile electronic device and provide one or more input interfaces that allow for interaction with the mobile electronic device.

### BACKGROUND

The mobile gaming segment of the broader gaming industry has experienced rapid and sustained growth. In 2022, the global gaming market generated approximately $184.4 billion in revenue, with mobile gaming accounting for roughly half of that total—$92.2 billion. Although mobile phones were not originally intended as gaming platforms, ongoing improvements in processing power, graphics capabilities, and network infrastructure have made modern smartphones fully capable of running complex, graphics-intensive games. However, one area in which mobile gaming continues to lag behind traditional console and PC gaming is in the availability and practicality of input accessories, particularly portable gaming controllers designed specifically for mobile devices.

Conventional game controllers designed for use with mobile phones typically connect via physical clamping mechanisms or specially designed phone cases that include dedicated attachment points. These solutions often lack universality across different phone models and tend to be bulky, making them inconvenient for everyday portability. Their size and configuration render them impractical for users who wish to keep a controller in their pocket or attached to their device throughout the day. As a result, many mobile gamers are forced to choose between portability and high-quality game control.

### SUMMARY OF PARTICULAR EMBODIMENTS

The present disclosure presents an attachable accessory, such as, but not limited to, a game controller, keyboard, touch pad, and/or additional display that may be removably attached to a mobile electronic device. The attachable accessory has a closed and expanded position (also referred to as the “open” position), and when in the closed position, it is compact for easy storage with or without the mobile electronic device attached to it. The attachable accessory may be used with any mobile electronic device of a similar size and type.

In particular embodiments, the attachable accessory is a game controller or other portable controller accessory for gaming or performing other interactions with a mobile electronic device, such as a smartphone. For example, the game controller may be a multi-input game controller that connects magnetically to mobile phones, offering a more elegant and detachable alternative to traditional clamp-based or case-based solutions. Certain technical challenges exist due to the wide variety of mobile phone form factors. Differences in phone dimensions, camera bump size and location, and the presence or placement of magnetic rings (such as Apple's MAGSAFE system) may complicate the mechanical and magnetic interface between the controller and the device. There is a need for a universal attachment mechanism that allows magnetically connectable mobile game controllers to be used effectively across a wide range of phone designs and form factors. Such a solution would improve portability, compatibility, and the overall user experience for mobile gamers. The solutions presented by the embodiments disclosed herein address these challenges.

The attachable accessory has an upper-case (housing) element and a lower-case (housing) element. The lower-case element has one or more input interfaces for interacting with an attached mobile electronic device. These input interfaces may be joysticks, touchpads, various buttons, switches, or other input devices. The attachable accessory is hereinafter variously referred to as a “portable controller accessory”, “portable input accessory”, “portable controller”, “portable input device”, “gaming controller”, or simply “controller”. The term “controller”, i.e., to be used for control, and “input device” or “input” are used interchangeably in these embodiments.

The attachable accessory is usable in various states, e.g., an attached idle (closed) state wherein the upper-case element is closed relative to the lower-case element such that the edges of the upper-case element are disposed directly on top of the edges of the lower-case element. In this way, when in the attached idle state, the attachable accessory is very compact and may be easily carried in the user's pocket. The attachable accessory may also be placed into an attached active expanded (open) state wherein the lower-case element is partially slid out from the upper-case element to expose the accessories' input interface(s) and place the input interface(s) in a location suitable for a user's hands/fingers to operate the interface(s) during gaming or other interaction with an associated mobile electronic device. Additionally, the attachable accessory may be placed in a detached state where the upper-case elements and lower-case elements are completely detached from one another. In the detached state, the lower-case element with its input interface(s) may be used with another computer system, or it may be used with the mobile electronic device at a distance from the attachable accessory.

In particular embodiments, an attachable accessory for mobile electronic devices is provided. The attachable accessory includes an upper-case element configured to secure a mobile electronic device and a lower-case element with one or more input interfaces disposed on a top portion of the lower-case element. The one or more input interfaces allow a user to interact with the mobile electronic device. The attachable accessory also includes an opening mechanism that couples the upper-case element to the lower-case element. The opening mechanism includes an operable actuator configured to couple the upper-case element to the lower-case element, wherein the opening mechanism enables the attachable accessory to move from a closed position to an expanded position.

In particular, embodiments of the opening mechanism enable the attachable accessory to move from a closed position to an expanded position. When the attachable accessory is in the closed position, the attachable accessory is in a compact configuration in which the upper-case element substantially overlays the lower-case element, and in which the top portion of the lower-case element is substantially covered by the upper-case element. When the attachable accessory is in the expanded position, the attachable accessory is in an expanded configuration in which the upper-case element is substantially displaced from the lower-case element and in which the top portion of the lower-case element is substantially exposed.

In particular embodiments, the attachable accessory includes a slider that is pivotally attached to the upper-case element. The slider may interact with the opening mechanism to move the attached accessory from a closed position to an expanded position. The expanded position may include where the upper-case element is disconnected from the lower-case element. When disconnected from the lower-case element, the slider may operate as a kick stand to support the upper-case element when positioned on a surface. The slider may be curved or have another shape so that when the attachable accessory is moved to the expanded position, the upper-case moves both in a direction that is away from the lower-case element and transverse to the lower-case element.

In particular embodiments, the opening mechanism includes a motor. The motor may be controlled by one or more user interfaces, by the mobile electronic device, or an application hosted by the mobile electronic device. The motor may exert a force on the slider or other component of the upper-case element to push the upper-case element toward the expanded position. As an example and not by way of limitation, the motor may be a rack and pinion motor, or it may turn a threaded rod attached to the upper-case element and/or slider.

In particular embodiments, the opening mechanism may include one or more springs. These springs may include one or more constant force springs, one or more dampening springs, a combination of the two, or any other type of spring. The springs release a force to propel the upper-case element to the expanded position when the interface, such as a latch or button, is pressed.

In particular embodiments, the input interfaces may take multiple forms. The input interface may take the form of a gaming controller and include such things as joysticks, various buttons, various switches, or other controllers for interacting with a game. The input interface may take the form of a keyboard, allowing a user to easily type on the attached mobile electronic device. The lower-case element may also include a digital display, which may also serve as a touch pad or another type of interface.

In particular embodiments, an attachable accessory for mobile electronic devices is provided. The attachable accessory includes an upper-case element configured to secure a mobile electronic device and a lower-case element with one or more input interfaces disposed on a top portion of the lower-case element. An opening mechanism that couples the upper-case element to the lower-case element and allows the attachable accessory to open to an expanded position and return to a closed position. The upper-case element includes a puck or an adjustable plate for securing the mobile electronic device to the upper-case element. The puck is connected to the top surface of the upper-case in such a way that the puck is movable from a first position to a second position parallel to the top surface of the upper-case.

In particular embodiments, the puck includes one or more elements for securing the mobile electronic device to the upper-case element. The puck may include magnets that connect to a magnetic ring in the mobile electronic device. The puck may instead or additionally be formed of a compliant material that includes an etched pattern forming a non-skid surface to allow the mobile electronic device to resist being unintentionally removed from the attachable accessory.

In particular embodiments, the puck may be connected to a top surface of the upper-case element through a hot shoe, cold shoe, or a movable pin. The hot shoe may be configured to wirelessly transfer electrical power or provide electrical power to the mobile electronic device and/or wirelessly transfer data through a wireless connection with the mobile electronic device. The puck may move both rotationally and transversely relative to the upper-case element and may be able to rotate an attached mobile electronic device from a portrait to a landscape orientation relative to the attachable accessory.

In particular embodiments, the attachable accessory includes handles or grips. These grips may be movable from a first compact storage position when the attachable accessory is in a closed position and may be movable to an extended position that allows a user to hold the grips with their hands when the attachable accessory is in the expanded position. The handles or grips may include straps that may be retracted when the handles or grips are not in use and deployed from a folded position when needed. The handles or grip may also be detachable from the attachable accessory.

In particular embodiments, the techniques described herein relate to an attachable accessory for mobile electronic devices including: an upper-case element configured to secure a mobile electronic device; a lower-case element with one or more input interfaces disposed on a top portion of the lower-case element, the one or more input interfaces allowing a user to interact with the mobile electronic device; and an opening mechanism configured to couple the upper-case element to the lower-case element, wherein: the opening mechanism enables the attachable accessory to move from a closed position to an expanded position; when the attachable accessory is in the closed position, the attachable accessory is in a compact configuration in which the upper-case element substantially overlays the lower-case element, and in which the top portion of the lower-case element is substantially covered by the upper-case element; when the attachable accessory is in the expanded position, the attachable accessory is in an expanded configuration in which the upper-case element is substantially displaced from the lower-case element and in which the top portion of the lower-case element is substantially exposed; and the opening mechanism includes an actuator, wherein the actuator is operable to cause the upper-case element and lower-case element to move relative to each other between the closed position and the expanded position.

In particular embodiments, the techniques described herein relate to an attachable accessory, wherein the actuator includes one or more springs that are operable to cause movement of the upper-case element from the closed position to the expanded position.

In particular embodiments, the techniques described herein relate to an attachable accessory, wherein the one or more springs include one or more of: one or more constant force springs; or one or more dampening springs.

In particular embodiments, the techniques described herein relate to an attachable accessory, wherein the actuator is disposed in one or more of: the lower-case element; or the upper-case element.

In particular embodiments, the techniques described herein relate to an attachable accessory, further including a slider which is pivotally attached to the upper-case element and receives a force from the actuator to move from a first position where the slider is substantially inside of the lower-case element to a second position where the slider is at least in part outside of the lower-case element.

In particular embodiments, the techniques described herein relate to an attachable accessory, wherein the opening mechanism is further operable to cause the upper-case element to detach from the lower-case element, and wherein the slider is operable to be used as a standalone kickstand for the upper-case element when positioned on a surface.

In particular embodiments, the techniques described herein relate to an attachable accessory, wherein the slider is curved to cause the upper-case element to move in a direction that is both away from and transverse to the lower-case element.

In particular embodiments, the techniques described herein relate to an attachable accessory, wherein the actuator includes a motor that is operable to cause movement of the upper-case element from the closed position to the expanded position, and from the expanded position to the closed position.

In particular embodiments, the techniques described herein relate to an attachable accessory, wherein the motor is controllable by the mobile electronic device.

In particular embodiments, the techniques described herein relate to an attachable accessory, wherein the motor is controllable by one or more interactive elements on the lower-case element.

In particular embodiments, the techniques described herein relate to an attachable accessory, wherein the motor is a rack and pinion motor, and wherein the motor is operable to move a slider attached to the upper-case element.

In particular embodiments, the techniques described herein relate to an attachable accessory, where the motor is operable to move a threaded rod attached to the upper-case element.

In particular embodiments, the techniques described herein relate to an attachable accessory, wherein the one or more input interfaces are configured to interact with a digital application executing on the mobile electronic device.

In particular embodiments, the techniques described herein relate to an attachable accessory, wherein the one or more input interfaces include a keyboard.

In particular embodiments, the techniques described herein relate to an attachable accessory, wherein the one or more input interfaces include a gaming controller.

In particular embodiments, the techniques described herein relate to an attachable accessory, wherein the one or more input interfaces include a digital display.

In particular embodiments, the techniques described herein relate to an attachable accessory, wherein the one or more input interfaces include a touch pad.

In particular embodiments, the techniques described herein relate to an attachable accessory, further including a first grip and a second grip, wherein the first grip and the second grip are movable from a first position that is inside of the lower-case element to a second position that is outside of the lower-case element.

In particular embodiments, the techniques described herein relate to a system including: a mobile electronic device; and an attachable accessory, wherein the attachable accessory includes: an upper-case element configured to secure the mobile electronic device; a lower-case element with one or more input interfaces disposed on a top portion of the lower-case element, the one or more input interfaces allowing a user to interact with the mobile electronic device; and an opening mechanism configured to couple the upper-case element to the lower-case element, wherein: the opening mechanism enables the attachable accessory to move from a closed position to an expanded position; when the attachable accessory is in the closed position, the attachable accessory is in a compact configuration in which the upper-case element substantially overlays the lower-case element, and in which the top portion of the lower-case element is substantially covered by the upper-case element; when the attachable accessory is in the expanded position, the attachable accessory is in an expanded configuration in which the upper-case element is substantially displaced from the lower-case element and in which the top portion of the lower-case element is substantially exposed; and the opening mechanism includes an actuator disposed in the lower-case element, wherein the actuator is operable to cause the upper-case element and lower-case element to move relative to each other between the closed position and the expanded position.

In particular embodiments, the techniques described herein relate to an attachable game controller including: an upper-case element configured to secure a mobile electronic device; a lower-case element with one or more gaming control elements disposed on a top portion of the lower-case element, the one or more gaming control elements allowing a user to interact with one or more gaming applications on the mobile electronic device; and an opening mechanism configured to couple the upper-case element to the lower-case element, wherein: the opening mechanism enables the attachable game controller to move from a closed position to an expanded position; when the attachable game controller is in the closed position, the attachable game controller is in a compact configuration in which the upper-case element substantially overlays the lower-case element, and in which the top portion of the lower-case element is substantially covered by the upper-case element; when the attachable game controller is in the expanded position, the attachable game controller is in an expanded configuration in which the upper-case element is substantially displaced from the lower-case element and in which the top portion of the lower-case element is substantially exposed; and the opening mechanism includes an actuator disposed in the lower-case element, wherein the actuator is operable to cause the upper-case element and lower-case element to move relative to each other between the closed position and the expanded position.

In particular embodiments, the techniques described herein relate to an attachable accessory for mobile electronic devices including: an upper-case element configured to secure a mobile electronic device, wherein: the upper-case element includes a puck that secures the mobile electronic device to the upper-case element; and the puck is connected to a top surface of the upper-case element in such a way that the puck is movable along a lateral axis from a first position to a second position parallel to the top surface of the upper-case element; a lower-case element with one or more input interfaces disposed on a top portion of the lower-case element, the one or more input interfaces allowing a user to interact with the mobile electronic device; and an opening mechanism configured to couple the upper-case element to the lower-case element, wherein the opening mechanism enables the attachable accessory to move from a closed position to an expanded position.

In particular embodiments, the techniques described herein relate to an attachable accessory, wherein the puck includes a first magnetic component configured to magnetically couple the puck to a second magnetic component in the mobile electronic device.

In particular embodiments, the techniques described herein relate to an attachable accessory, wherein the puck connects to the top surface of the upper-case element through a shoe.

In particular embodiments, the techniques described herein relate to an attachable accessory, wherein the shoe is configured to wirelessly transfer data to or from the mobile electronic device.

In particular embodiments, the techniques described herein relate to an attachable accessory, wherein the shoe is configured to wirelessly transfer electrical power to or from the mobile electronic device.

In particular embodiments, the techniques described herein relate to an attachable accessory, wherein the puck is operable to move in a direction parallel to a first axis of the top surface of the upper-case element, and wherein the puck is further operable to move in a rotational direction relative to the first axis.

In particular embodiments, the techniques described herein relate to an attachable accessory, wherein the puck is attached to the top surface of the upper-case element through a track that extends along the first axis and includes at least two curved portions that allow the puck to move in the rotational direction.

In particular embodiments, the techniques described herein relate to an attachable accessory, wherein when the puck is moved in the rotational direction the mobile electronic device is moved from a portrait to a landscape orientation.

In particular embodiments, the techniques described herein relate to an attachable accessory, wherein a top surface of the puck includes a compliant material that is deformable to provide a friction fit when the mobile electronic device is placed on the top surface.

In particular embodiments, the techniques described herein relate to an attachable accessory, wherein the puck includes at least two parts that are able to slide relative to each other to make the puck larger or smaller.

In particular embodiments, the techniques described herein relate to an attachable accessory, wherein a top surface of the puck includes an etched pattern on at least one surface that is opposite the top surface of the upper-case element.

In particular embodiments, the techniques described herein relate to an attachable accessory, wherein the etched pattern acts as a non-skid surface, to allow the mobile electronic device to resist being unintentionally removed from the attachable accessory.

In particular embodiments, the techniques described herein relate to an attachable accessory, further including a first grip and a second grip, wherein the first grip and the second grip are movable from a first position that is inside of the lower-case element to a second position that is outside of the lower-case element.

In particular embodiments, the techniques described herein relate to an attachable accessory, wherein the first grip and the second grip are configured to be detached from the lower-case element.

In particular embodiments, the techniques described herein relate to an attachable accessory, wherein the first grip and the second grip each include a strap on a lower surface that is configured to secure a corresponding one of the first grip and the second grip to one or more of a finger, hand, or wrist of a user of the attachable accessory.

In particular embodiments, the techniques described herein relate to an attachable accessory, wherein at least one of the first grip and the second grip includes embedded electronics configured to provide additional sensory input, including but not limited to temperature, motion, touch, force and power.

In particular embodiments, the techniques described herein relate to an attachable accessory, wherein at least one of the first grip and the second grip includes embedded electronics configured to provide additional output, including but not limited to vibration, illumination, haptics, location and audio.

In particular embodiments, the techniques described herein relate to an attachable accessory, wherein the one or more input interfaces are configured to interact with a digital application executing on the mobile electronic device.

In particular embodiments, the techniques described herein relate to an attachable accessory, wherein the one or more input interfaces include a keyboard.

In particular embodiments, the techniques described herein relate to an attachable accessory, wherein the one or more input interfaces include a gaming controller.

In particular embodiments, the techniques described herein relate to a system including: a mobile electronic device; and an attachable accessory, wherein the attachable accessory includes: an upper-case element configured to secure the mobile electronic device wherein: the upper-case element includes a puck that secures the mobile electronic device to the upper-case element; and the puck is connected to a top surface of the upper-case element in such a way that the puck is movable from a first position to a second position parallel to the top surface of the upper-case element; a lower-case element with one or more input interfaces disposed on a top portion of the lower-case element, the one or more input interfaces allowing a user to interact with the mobile electronic device; and an opening mechanism configured to couple the upper-case element to the lower-case element, wherein the opening mechanism enables the attachable accessory to move from a closed position to an expanded position.

In particular embodiments, the techniques described herein relate to an attachable game controller including: an upper-case element configured to secure a mobile electronic device, wherein: the upper-case element includes a puck that secures the mobile electronic device to the upper-case element; and the puck is connected to a top surface of the upper-case element in such a way that the puck is movable from a first position to a second position parallel to the top surface of the upper-case element; a lower-case element with one or more gaming control elements disposed on a top portion of the lower-case element, the one or more gaming control elements allowing a user to interact with one or more gaming applications on the mobile electronic device; and an opening mechanism configured to couple the upper-case element to the lower-case element, wherein the opening mechanism enables the attachable game controller to move from a closed position to an expanded position.

The embodiments disclosed herein are only examples, and the scope of this disclosure is not limited to them. Particular embodiments may include all, some, or none of the components, elements, features, functions, operations, or steps of the embodiments disclosed herein. Embodiments according to the invention are in particular disclosed in the attached claims directed to a method, a storage medium, a system and a computer program product, wherein any feature mentioned in one claim category, e.g. method, can be claimed in another claim category, e.g. system, as well. The dependencies or references back in the attached claims are chosen for formal reasons only. However any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

### BRIEF DESCRIPTION OF THE DRAWINGS

FIG. 1A is a top view of an attachable accessory in its closed state with a mobile electronic device attached, according to an embodiment.

FIG. 1B is a top view of an attachable accessory in its expanded state with a mobile electronic device attached, according to an embodiment.

FIG. 2A is a top view of an attachable accessory in its expanded state, configured as a game controller, according to an embodiment.

FIG. 2B is a top view of an attachable accessory in its expanded state, configured as a keyboard, according to an embodiment.

FIG. 2C is a top view of an attachable accessory in its expanded state, configured as a digital display, according to an embodiment.

FIG. 2D is a top view of an attachable accessory in its expanded state, configured as a touch pad configured to interact with a stylus, according to an embodiment.

FIG. 3A is a right-side view of an attachable accessory in its expanded or active state, according to an embodiment.

FIG. 3B is a bottom view of an attachable accessory in its expanded or active state, according to an embodiment.

FIG. 3C is a top view of an attachable accessory in its expanded or active state, configured as a gaming controller, according to an embodiment.

FIG. 4A is a bottom view of an attachable accessory in its expanded or active state, according to an embodiment.

FIG. 4B is a bottom view of an attachable accessory in its closed or inactive state, according to an embodiment.

FIG. 5 is a top view of a top portion of a lower-case element of an attachable accessory, according to an embodiment.

FIG. 6A is a bottom view of a top portion of a lower-case element when the attachable accessory is in its closed or inactive state, according to an embodiment.

FIG. 6B is a bottom view of a top portion of a lower-case element when the attachable accessory is in its expanded or active state, according to an embodiment.

FIGS. 7A and 7B are detailed views of an opening mechanism according to an embodiment.

FIGS. 8A and 8B are detail views of an opening mechanism according to an embodiment.

FIG. 9 is a detailed view of the opening mechanism and the bottom view of the upper-case element according to an embodiment.

FIG. 10A is a bottom view of an attachable accessory in its expanded or active state according to an embodiment.

FIGS. 10B and 10C are a bottom view of a top portion of a lower-case element and the upper-case element when the attachable accessory is in its expanded or active state, according to an embodiment.

FIG. 10D is a side view showing the opening mechanism according to an embodiment.

FIG. 11A is a top view of an opening mechanism according to an embodiment.

FIG. 11B is a top view of the opening mechanism and upper-case element according to an embodiment.

FIG. 12A is a side view of the attachable accessory and its opening mechanism in an expanded or active state, according to an embodiment.

FIG. 12B is a side view of the attachable accessory and its opening mechanism in a closed or inactive state, according to an embodiment.

FIG. 12C is a top view of the upper-case element and opening mechanism, according to an embodiment.

FIG. 13A is a detail view of a pivoting mechanism, according to an embodiment.

FIG. 13B is a cut-away view of the pivoting mechanism of FIG. 13A, according to an embodiment.

FIGS. 13C and 13D are detail views of a pivoting mechanism, according to an embodiment.

FIG. 14A is a cross-sectional view of the lower-case element, according to an embodiment.

FIG. 14B is a cross-sectional view of the attachable accessory, according to an embodiment.

FIG. 15 is a side view of the attachable accessory, according to an embodiment.

FIG. 16A is a cross-sectional view of the attachable accessory, according to an embodiment.

FIG. 16B is a detail view of the connection between the upper-case element and the lower-case element, according to an embodiment.

FIG. 17 is a side view of the attachable accessory where the upper-case element is detached from the lower-case element, according to an embodiment.

FIG. 18A is a left side view of the upper-case element with an attached mobile electronic device, according to an embodiment.

FIG. 18B is a bottom view of the upper-case element with an attached mobile electronic device, according to an embodiment.

FIG. 18C is a right-side view of the upper-case element with an attached mobile electronic device, according to an embodiment.

FIG. 19 is a side view of the attachable accessory in its closed configuration, according to an embodiment.

FIG. 20A is a top view of the attachable accessory with a magnetic plate, according to an embodiment.

FIG. 20B is a top view of the attachable accessory with a mobile electronic device attached, according to an embodiment.

FIG. 21 is a view of a mobile electronic device, according to an embodiment.

FIGS. 22A and 22B are top views of the upper-case element with a magnetic plate, according to an embodiment.

FIG. 23A is a top view of the upper-case element with a magnetic plate, according to an embodiment.

FIG. 23B is a top view of the upper-case element with a track for attaching the magnetic plate, according to an embodiment.

FIG. 24 is a top view of the upper-case element with a magnetic plate, according to an embodiment.

FIG. 25 is a top view of an adaptor plate with embedded magnetic components, according to an embodiment.

FIGS. 26A-26C are top views of the upper-case element with the adaptor plate with embedded magnetic components, according to an embodiment.

FIG. 27A is a top view of a handle or grip, according to an embodiment.

FIG. 27B is a side view of a handle or grip, according to an embodiment.

FIG. 28 is a bottom view of a handle or grip, according to an embodiment.

FIG. 29 is a side view of a handle or grip, according to an embodiment.

FIGS. 30A and 30B are views of a strap, according to an embodiment.

### DESCRIPTION OF EXAMPLE EMBODIMENTS

### Introduction

The following description of the embodiments refers to the accompanying drawings. The same reference numbers in different drawings identify the same or similar elements. The following detailed description does not limit the invention. The embodiments to be discussed herein are not limited to the configurations described below but may be extended to other suitable arrangements.

Reference throughout the specification to “particular embodiments,” “one embodiment,” or “an embodiment” means that a particular feature, structure, or characteristic described in connection with an embodiment is included in at least one embodiment of the subject matter disclosed. Thus, the appearance of the phrases “in particular embodiments” or “in an embodiment” in various places throughout the specification does not necessarily refer to the same embodiment. Further, the particular features, structures, or characteristics may be combined in any suitable manner in one or more embodiments.

In particular embodiments, an attachable accessory may be a multi-input device such as, but not limited to, a game controller, a supplemental keyboard, a supplemental digital display, a touch screen, or any other accessory providing a portable controller accessory for use with a mobile device such as a mobile phone or a smart phone. The attachable accessory may have an upper-case element (housing) and a lower-case element (housing). Hereafter, the attachable accessory may be variously referred to as a “portable controller accessory”, “portable input accessory”, “portable controller”, “portable input device”, “accessory”, “gaming controller”, or simply “controller”. The term “controller”, i.e., to be used for control, and “input device” or “input” may be used interchangeably in these embodiments.

The attachable accessory may be usable in various states, e.g., a closed idle state where the upper-case element is closed relative to the lower-case element such that the edges of the upper-case element are disposed directly on top of the edges of the lower-case element. When closed, the top portion of the lower-case element may be substantially covered by the upper-case element. When in this closed configuration, the attachable accessory may be compact and similar in size to the mobile electronic device. In particular embodiments, the attachable accessory in the compact closed state may be able to be easily carried in a user's pocket along with a mobile electronic device, such as, but not limited to, a smartphone.

The attachable accessory may also be placed into an expanded or open active state where the lower-case element is partially slid out or completely separated from the upper-case element. When in the expanded state, the accessory's interface, such as, but not limited to, a touch screen, keyboard, gaming controls, and other elements for user interaction, are in a location suitable for a user to interact with them, for example, with their hands/fingers. Additionally, the attachable accessory may be placed in a detached state where the upper-case and lower-case elements are completely detached from one another. In the detached state, the lower-case element with its controls may be used with another system, or it may be used with the mobile electronic device at a distance from the attachable accessory and/or one or more of the interfaces on the lower-case element.

In any of the various states (configurations) described above, the mobile electronic device may be attached to the upper-case element of the attachable accessory via magnets and/or through a movable and adjustable puck. Additionally, the upper-case element may include a kickstand that is operative to enable the upper-case element as well as the attached mobile electronic device to be supported on a substantially flat surface at an angle relative to the lower-case element and its included interface elements (in either landscape or portrait orientation). In particular embodiments, the attachable accessory may also function as a battery bank for the mobile electronic device, and/or it may charge the mobile electronic device while the user is using it, for example, to play games or other applications running on the mobile electronic device. According to various embodiments, these and other features of the attachable accessory will now be further described with respect to the Figures.

### Attachable Accessory Overview

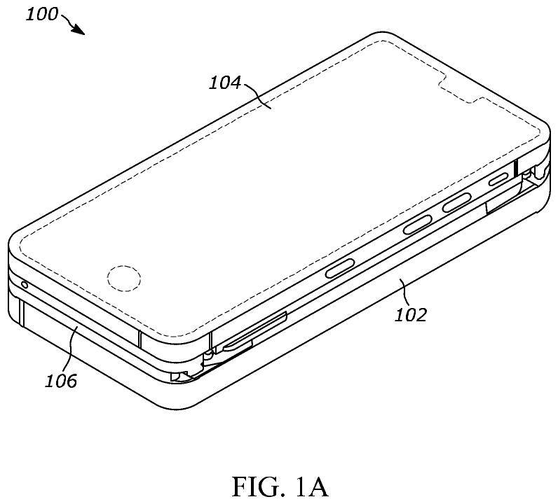

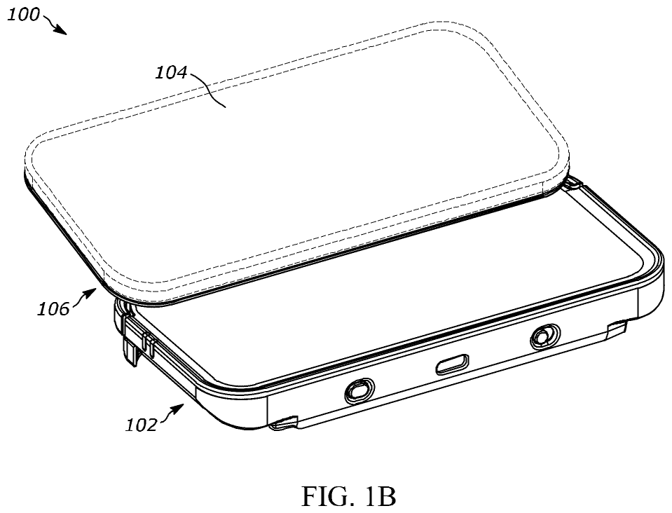

FIGS. 1A and 1B depict the attachable accessory 100 with a mobile electronic device 104 secured to an upper-case element 106 of the attachable accessory 100. As shown in FIG. 1A, the attachable accessory 100 is in a closed position, which is a compact configuration where the upper-case element 106 substantially overlays or covers the lower-case element 102. In other words, the upper-case element 106 and the lower-case element 102 are substantially aligned when in the closed position. FIG. 1B shows the attachable accessory 100 in the expanded position in which the upper-case element 106 is substantially displaced from the lower-case element 102, with at least the top portion of the lower-case element 102 substantially exposed. In other words, the upper-case element 106 and the lower-case element 102 are substantially unaligned or apart (aside from connecting elements) when in the expanded position.

While the attachable accessory 100 is shown as being substantially rectangular, corresponding to the approximate shape of a smartphone or other similar device, the attachable accessory 100 may take any suitable shape and, in general, would conform with part or all of any mobile electronic device 104, either attached or associated with the attachable accessory 100. The mobile electronic device 104 may be a smartphone, a flip phone, or any other suitable type of mobile phone. Additionally, the mobile electronic device 104 may be such things as a personal digital assistant (PDA), tablet computer, a notebook computer, or any other type of mobile electronic device 104 that is able to interact with and attach to the attachable accessory 100. To accommodate mobile electronic devices 104 of different sizes, the upper-case element 106 may have its dimensions conform to the dimensions of the mobile electronic device 104, while the lower-case element 102 may have one or more dimensions that are smaller, larger, or otherwise different than those of the upper-case element 106.

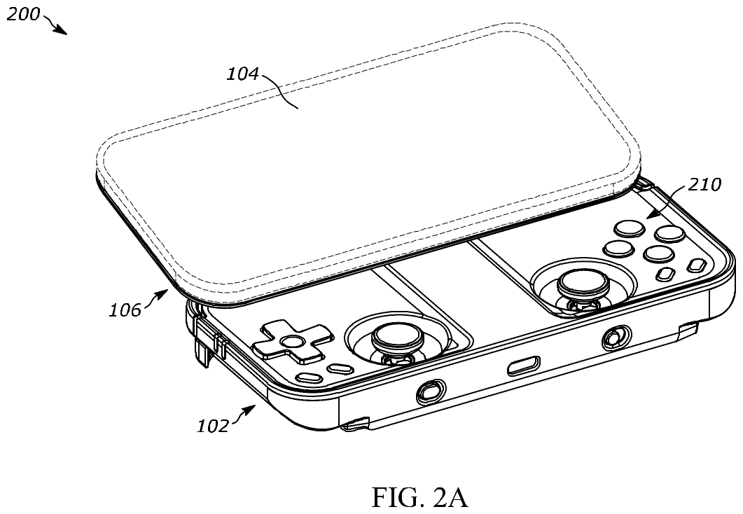

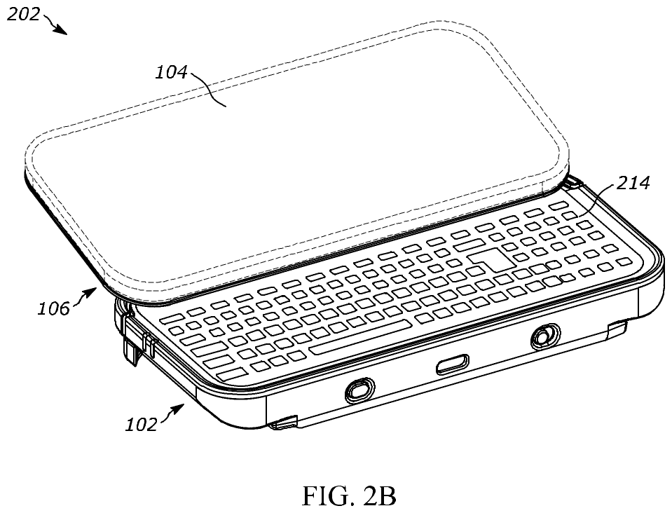

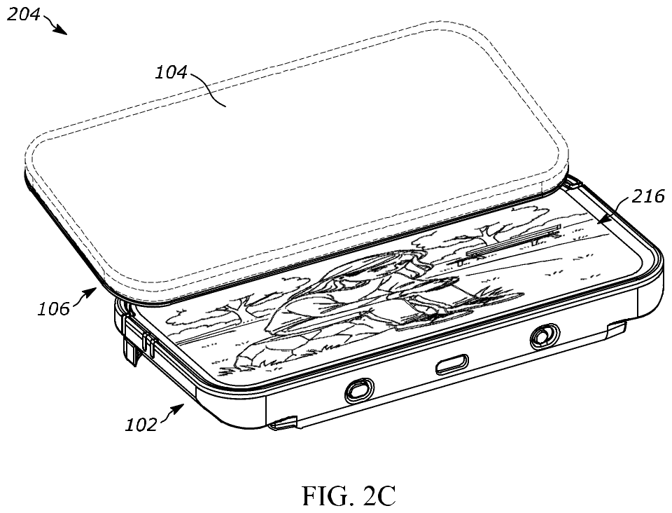

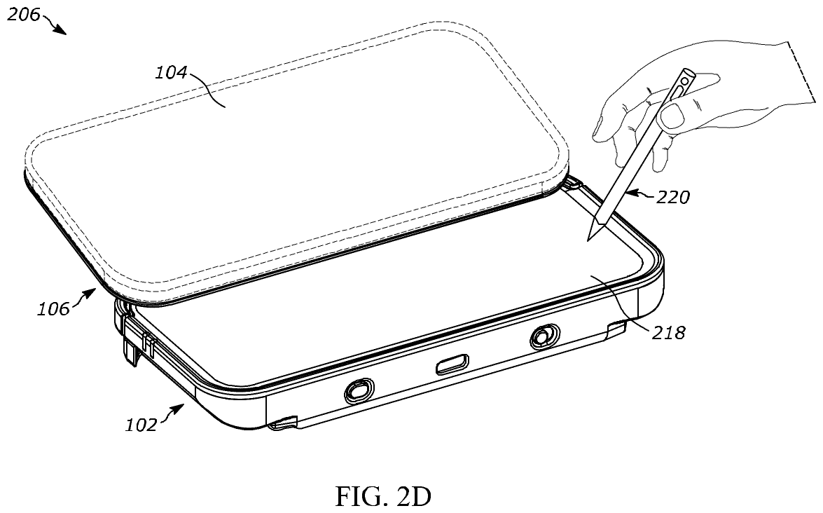

FIG. 2A depicts the attachable accessory 100 functioning as a gaming controller 200 according to a particular embodiment. When functioning as a gaming controller 200, the attachable accessory 100 includes an input interface that includes one or more gaming control elements 210 such as, but not limited to, face buttons, a D-pad, and one or more analog control sticks or joysticks, all of which may be configured to be used by the user's thumbs or fingers. The gaming control elements 210 may be formed in one or more depressions in the attachable accessory 100. These depressions may enable the gaming control elements 210 to be below the upper surface of the lower-case element 102 so that when the upper-case element 106 is placed in the closed compact position, such as shown in FIG. 1A, the bottom surface of the upper-case element 106 does not touch or impact the gaming control elements 210.

FIG. 2B depicts the attachable accessory 100 functioning as an attachable keyboard 202 according to a particular embodiment. When functioning as an attachable keyboard 202, the attachable accessory 100 includes a keyboard 214 on the surface of the lower-case element 102. This keyboard 214 may include mechanical keys, one or more haptic interfaces, or other forms of touchscreens. Additionally, the keyboard 214 may take any common form, such as QWERTY or other common configurations. The keyboard is not limited to the Latin alphabet and may include any symbols, emojis, emoticons, or other icons, letters, or numbers that are commonly used to communicate and/or type in a particular language, dialect, or in a particular region.

FIG. 2C depicts the attachable accessory 100 functioning as an attachable additional digital display screen 204. The attachable digital display screen 204 includes an additional screen 216 in the lower-case element 102. This additional screen 216 may take the place of the screen on the mobile electronic device 104 or serve as a second screen and may have improved resolution or have other features, including displaying three-dimensional images or providing augmented reality. The additional screen 216 may take any form and may be a liquid crystal display (LCD), a light-emitting diode (LED) display, an organic light-emitting diode (OLED) display, or any other type of display.

FIG. 2D depicts the attachable accessory 100 functioning as an attachable touch screen 206. The attachable touch screen 206 includes a touch pad 218 or another similar type of tactile sensor. The touch pad 218 may be a flat surface, or it may include a display screen such as that described above with regards to FIG. 2C. The touch pad 218 may use capacitive sensing or resistive sensing and may work with a stylus 220, a user's fingers, or any other type of input device.

Expandable Attachable Accessory with Slider

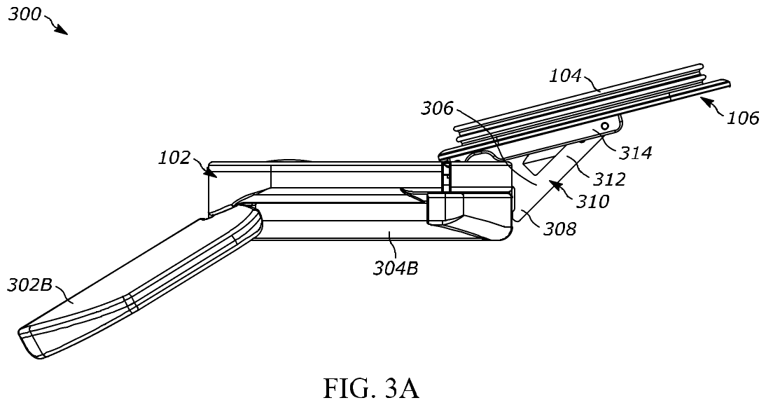

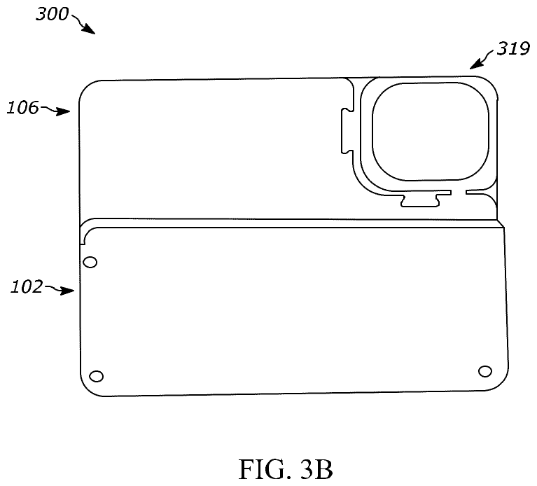

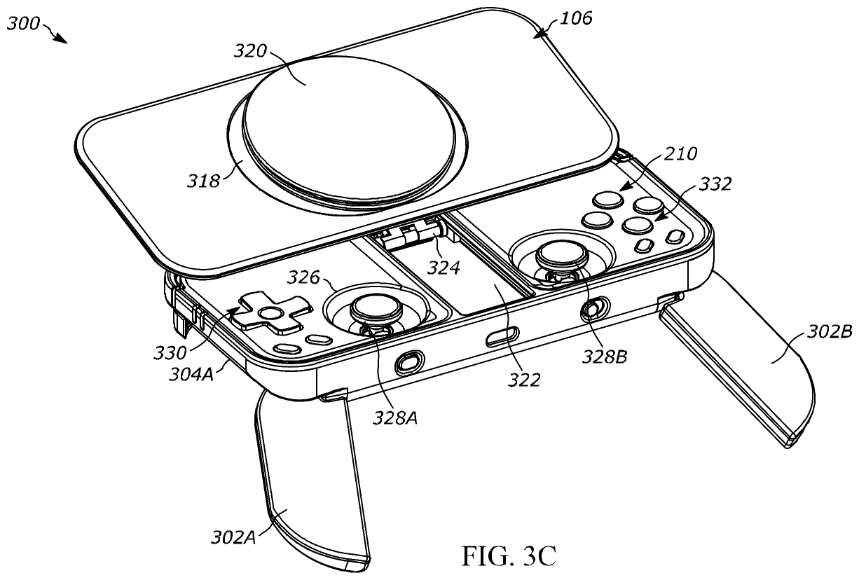

FIGS. 3A-3C illustrate an attachable accessory 300 that is attachable to a mobile electronic device 104 according to particular embodiments of the disclosure. The attachable accessory 300 may be the same or similar to that of the attachable accessory 100 of FIGS. 1A-2D. Specifically, FIGS. 3A-3C show the attachable accessory 300 in an expanded (i.e., open) configuration from different perspectives, with the mobile electronic device 104 attached as shown in FIG. 3A and detached as shown in FIGS. 3B and 3C. The attachable accessory 300 may incorporate the features described above and may be compatible with the other embodiments of the controller described above with reference to FIGS. 1A-2D. Although the mobile electronic device 104 and the attachable accessory 300 are illustrated in the figures as particular devices with particular shapes, sizes, and configurations in a particular manner, this disclosure contemplates any mobile electronic devices and any controllers with any suitable shapes, sizes, and configurations in any suitable manner.

In particular embodiments, an upper-case element 106 of the attachable accessory 300 may be movably connected to a lower-case element 102 via an actuation interface or opening mechanism 310, which is designed to provide a swift transition between the closed position and the expanded position of the attachable accessory 300. The opening mechanism 310 may be coupled between the upper-case element 106 and the lower-case element 102, allowing them to move or slide relative to each other. As an example and not by way of limitation, the opening mechanism 310 may include an arm assembly 312, the ends of which may be movably (e.g., rotatably) connected to the upper-case element 106 at an upper-case connection such as, but not limited to sliding rails 314 and the lower-case element 102 at an opening 308 in the lower-case element 102. The arm assembly 312 may additionally include a support arm 306 that may provide support to the arm assembly 312 and/or, in particular embodiments, serve as a kick stand to support the upper-case element 106 when configured to separate from the lower-case element 102.

While the opening mechanism 310 is shown in a particular configuration in FIG. 3A, it may take other forms. As an example and not by way of limitation, the connection may be achieved via hinges, joints, pins, linkages, or other suitable connectors as shown in FIG. 3C. In the closed position, the arm assembly 312 may be received inside the lower-case element 102, such as folded within a first sliding rail 322 on the top surface of the lower-case element 102 as shown, for example, in FIG. 3C. When expanded, at least a portion of the arm assembly 312 may extend out from the lower-case element 102, pushing the upper-case element 106 away from the lower-case element 102 to the expanded position.

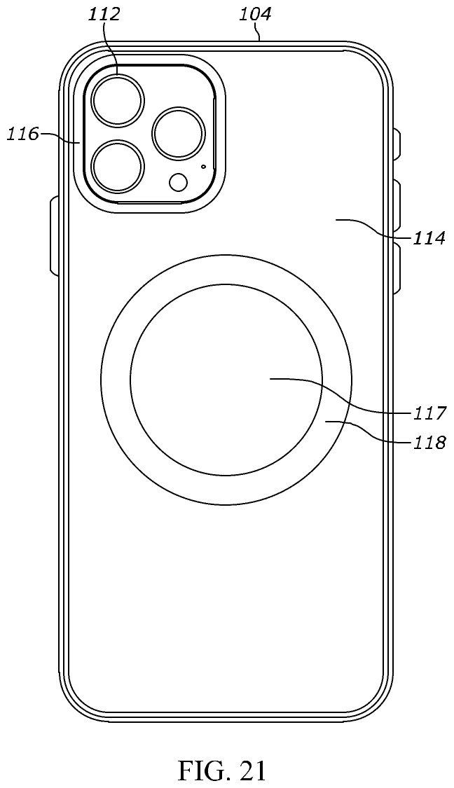

Turning to FIG. 3B, a view from the bottom of the attachable accessory 300 is shown. In particular, embodiments, the upper-case element 106, as shown in FIG. 3B, includes an adjustable camera bump opening 319. This allows the camera(s) or other components of an attached mobile electronic device 104 to be protected in the upper-case element 106 and/or still be functional through the back of the upper-case element 106. Different mobile electronic devices, such as mobile phones, have different form factors. For example, FIG. 21 shows a first mobile electronic device 104 having a first form factor corresponding to a mobile phone, however mobile electronic devices 104 may come in many different configurations with more or less cameras 112, a bigger or smaller camera bump 116, and/or the camera bump being located at other positions on the attached mobile electronic device 104.

The form factor of the mobile electronic device 104 may have a different length, a different width, and/or a different thickness. Additionally, the camera bump 116 associated with mobile electronic device 104 may have one or more of a different size, a different shape, and/or a different location as compared to other mobile electronic devices 104. In this regard, those skilled in the art will appreciate that a “camera bump” 116 refers to an area on the back of a mobile electronic device 104 that contains one or more camera lenses and, potentially, one or more additional sensors or other related devices (e.g., a flash device). To protect the camera lenses, the camera bumps 116 typically have walls that are raised relative to the rest of the back surface 114 of the mobile electronic devices 104.

Accordingly, and considering the previously described controller embodiments, while a typical opening 319 in the upper-case element 106 may fit over the back of some mobile electronic devices 104, the typical opening 319 may not fit over the camera bump, e.g., camera bump 116 of other mobile electronic devices 104. This challenge is associated with different mobile electronic devices 104 form factors, and in particular, is associated with different camera bumps 116. The challenge may be addressed in a number of different ways. One way is to fabricate a different upper-case element 106, for every mobile electronic device 104 having a different camera bump 116 form factor wherein the opening 319 in each different upper-case element 106 is sized, shaped, and located to accommodate the camera bump 116 associated with a specific corresponding mobile electronic device 104 model or models. Another way to address this challenge is to make opening 319 large enough (in both the horizontal and vertical directions) such that any existing camera bump 116 will fit through the enlarged opening 319. Still another way to address this challenge is to eliminate opening 319 entirely, as seen in the upper-case element 106 shown in FIG. 3C. Yet another way to address this challenge is to provide a variably-sized camera bump opening 319 by using a removable insert, such as the opening 319 in the upper-case element 106, a bottom view of which is shown in FIG. 3B. This latter embodiment enables the opening 319 to have a first size when the removable camera bump insert is attached, e.g., via magnets represented as two rectangles in the FIG. 3B or by other means, and for the opening 319 to have a second, larger size when the removable camera bump insert is removed.

FIG. 3C shows a particular embodiment of the attachable accessory 300 where the mobile electronic device 104 is not attached to the upper-case element 106. While shown as a game controller, the attachable accessory 300 may take any of the forms described above with regard to FIGS. 2A-2D and is not limited to the configuration shown in FIG. 3C.

In particular embodiments, the attachable accessory 300 is configured as a gaming controller 200 and the attachable accessory 300 may have a plurality of gaming control elements 210 including but not limited to, four face buttons 332 that are may be labeled X, A, B, and Y, which are frequently seen in gaming controllers. A D-pad 330, and two analog control sticks: a left analog stick 328A and a right analog stick 328B, i.e., joysticks, all of which are configured to be used by the user's thumbs. The gaming control elements 210 are disposed in two recesses formed in the lower-case element 102. These recesses may be oval as shown or may take other forms without departing from the disclosure. These recesses enable the gaming control elements 210 to be below the upper surface of the lower-case element 102 so that when the upper-case element slides down to cover the lower-case element 102, the bottom surface of the upper-case element 106 does not touch or impact the gaming control elements 210. Further, as shown, the left analog stick 328A and the right analog stick 328B reside in circular recesses 326, allowing for multiple degrees of movement without being significantly higher than the surface of the lower-case element 102. The disclosure is not limited to the specific configuration of the gaming control elements 210 and the top surface of the lower-case element 102 and the attachable accessory 300 may have any arrangement of the gaming control elements 210 and lower-case element 102 that allows the lower-case element 102 and upper-case element 106 to move to a closed position without interfering or damaging the gaming control elements 210.

In particular embodiments, the attachable accessory 300 includes various electrical components discussed or implied for interacting with the mobile electronic device 104 and performing the various functions described herein. The various electrical components may be mounted in the lower-case element 102 or alternatively distributed as appropriate in the lower-case element 102, upper-case element 106, and/or one or more of the left grip 302A and right grip 302B. The various electrical components may reside on one or more printed circuit boards (PCBs) housed within the lower-case element 102 and include one or more integrated circuits (ICs) that are connected to the gaming control elements 210 and/or other components of the attachable accessory 300. More information on electrical components and circuitry may be found in U.S. patent application Ser. No. 18/651,754, filed 1 May 2024, which is incorporated by reference.

In particular embodiments, the attachable accessory 300 may include a left grip 302A and a right grip 302B. In the expanded configuration, the left grip 302A and right grip 302B extend out and below the lower-case element 102. When in the compact closed configuration, the attachable accessory 300 includes a left opening 304A and a right opening 304B that receive the left grip 302A and right grip 302B. In particular, embodiments of the left grip 302A and right grip 302B may be removably magnetically attached or attached by other means to the attachable accessory 300. The left grip 302A and right grip 302B may include retractable straps or other means for securing the left grip 302A and right grip 302B to a user's hand, wrist, or finger(s) when using the attachable accessory 300 as a game controller.

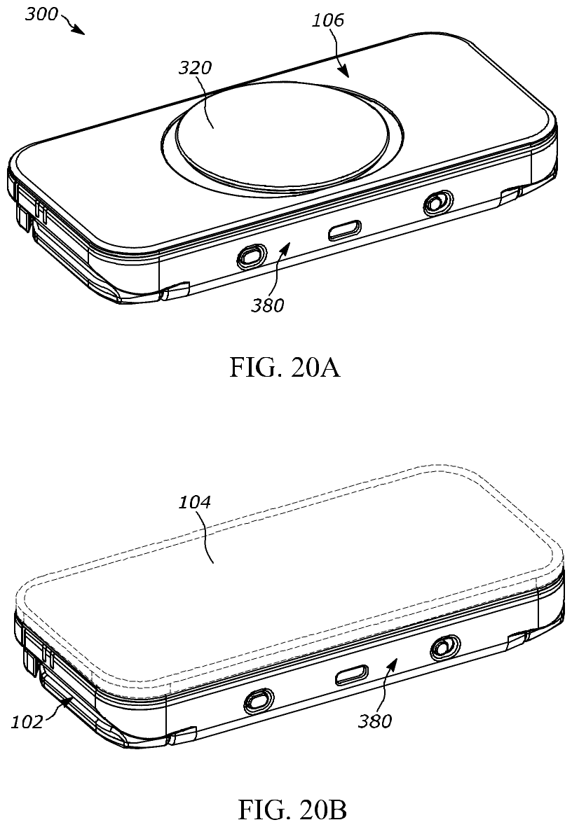

Turning to the upper-case element 106, in particular embodiments, the upper-case element 106 may include a plate or upper surface 318 or another surface for securely attaching the mobile electronic device 104. This upper surface 318 may include a puck 320 that may be round (as shown), rectangular, or any other appropriate shape that allows the puck 320 to removably secure the mobile electronic device 104 to the upper-case element 106. In particular embodiments, the puck may include one or more magnets configured to interact with the MAGSAFE ring 118 of the mobile electronic device 104. As will be described below with regards to FIGS. 20A-26C, the puck 320 may take many forms as well as be able to move in both a transverse direction and rotational directions relative to the upper surface 318 of the upper-case element 106.

In particular embodiments, the upper-case element 106 may be attached or coupled to the lower-case element 102 by an opening mechanism 310. As previously discussed, this opening mechanism 310 may include a pivot or hinge 324 that allows the upper-case element 106 and any attached mobile electronic device 104 to pivot at various angles relative to a user holding the attachable accessory 100. In particular embodiments the upper-case element is able to pivot based on feedback from a gyroscope or other similar device located in the mobile electronic device 104 or attachable accessory 300 so that the screen of the mobile electronic device 104 keeps a same orientation to the user's eyes no matter how the lower-case element 102 is moved. Additionally, or alternatively, the upper-case element is able to pivot based on instructions from one or more digital applications executed or hosted by the mobile electronic device 104.

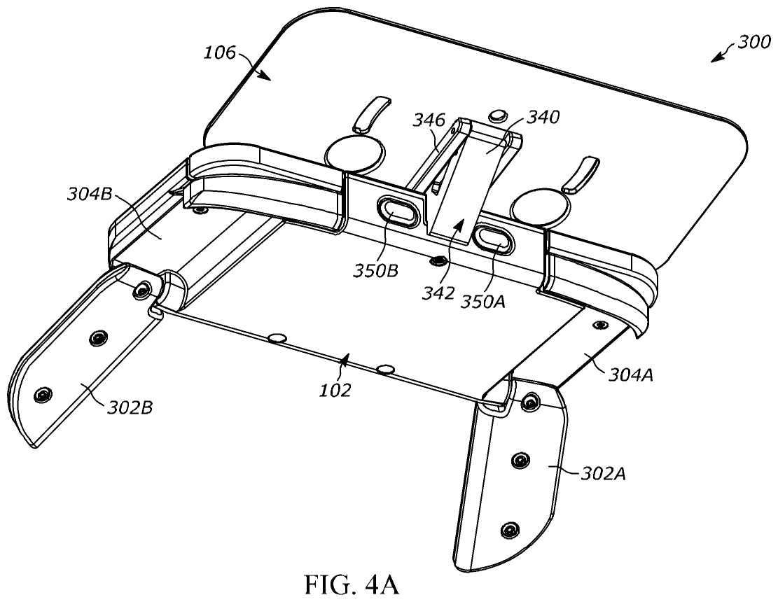

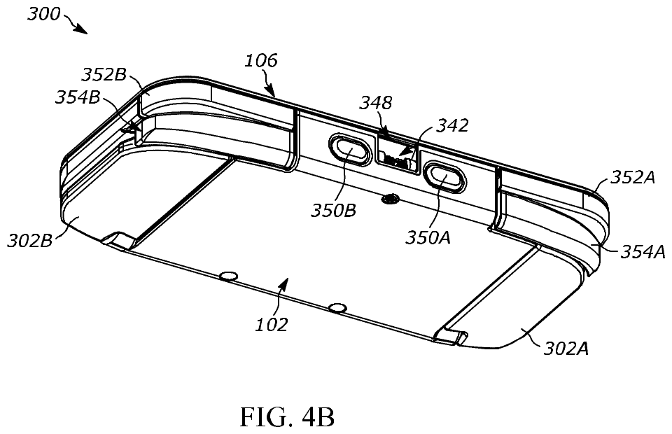

FIGS. 4A and 4B show a view of the attachable accessory 300 of particular embodiments from the back. As previously discussed, the upper-case element 106 is attached via an opening mechanism 340 that includes rails 346 and an angled portion 342 for supporting the upper-case element 106 when the attachable accessory 300 is in the expanded position. When in the closed position as shown in FIG. 4B, the angled portion 342 and other components of the opening mechanism 340 may be positioned inside the lower-case element 102 by entering an opening 348 in the lower-case element 102. When a user decides to open the attachable accessory 300, the opening mechanism 340 then exits out the opening 348, and the attachable accessory 300 opens up to the expanded position shown in FIG. 4A.

In particular embodiments, the lower-case element 102 includes one or more push buttons, such as two push buttons 350A and 350B. While shown on the back or rear portion of the lower-case element 102, one or more of the two push buttons 350A and 350B may be located at other locations, such as, but not limited to, a top or upper surface of the lower-case element 102. In use, the user may press on one or both of the two push buttons 350A and 350B to cause the opening mechanism 340 to open the attachable accessory 300 from a closed configuration shown in FIG. 4B to the expanded configuration shown in FIG. 4A. As an example and not by way of limitation, the two push buttons 350A and 350B may be operatively coupled to the locking elements and/or the spring to control actuation of the opening mechanism 340 to place the attachable accessory 300 in the expanded position shown in FIG. 4A.

In particular embodiments, lower-case elements 102 as shown in FIG. 4B includes additional controls for use with the attached mobile electronic device 104. These may include a right top button 352B, a right bottom button 354B, a left top button 352A, and a right bottom button 354A. The buttons may be standard pressure-sensitive push buttons, analog sensors, switches, or other types of inputs. These buttons may have specific uses with particular games or applications hosted by the mobile electronic device 104. For example, they may function as left and right triggers within a gaming application.

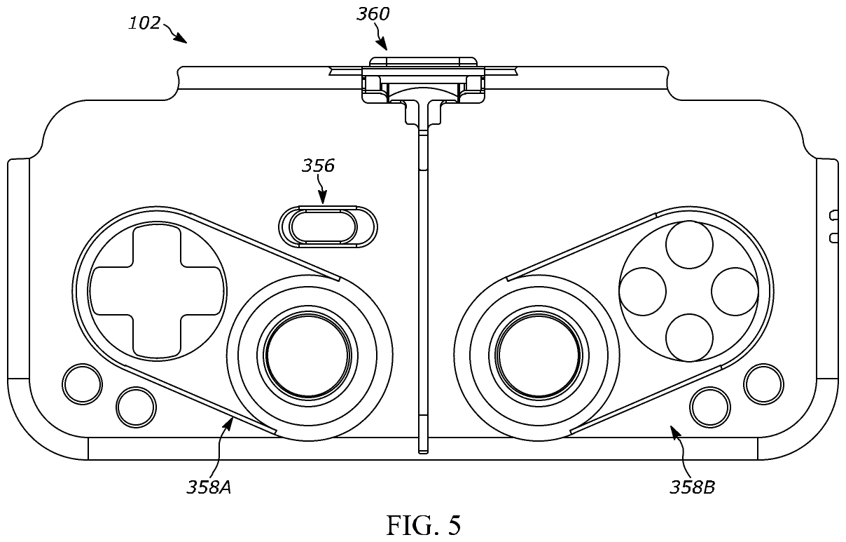

FIGS. 5-9 illustrate particular embodiments of the lower-case element 102 that includes details of an opening mechanism 340 that uses mechanical or spring-based force to allow or cause the attachable accessory 300 to move from the closed compact form of FIG. 1A to the open or expanded form of FIG. 1B. In particular embodiments as illustrated in FIGS. 5-9, the upper-case element 106 may be potentially removed or separated from the lower-case element 102.

Similar to the gaming controller 200 described above, the lower-case element 102 shown in FIGS. 5-9 is configured as a gaming controller 200. However, the lower-case element 102 shown FIGS. 5-9 may have any configurations, including any of those shown in FIGS. 2A-2D. lower-case element 102, is shown as a gaming controller 200 only for explanation purposes and is not limiting. As shown in FIG. 5, the lower-case element 102 in particular embodiments includes left gaming controls 358A and right gaming controls 358B.

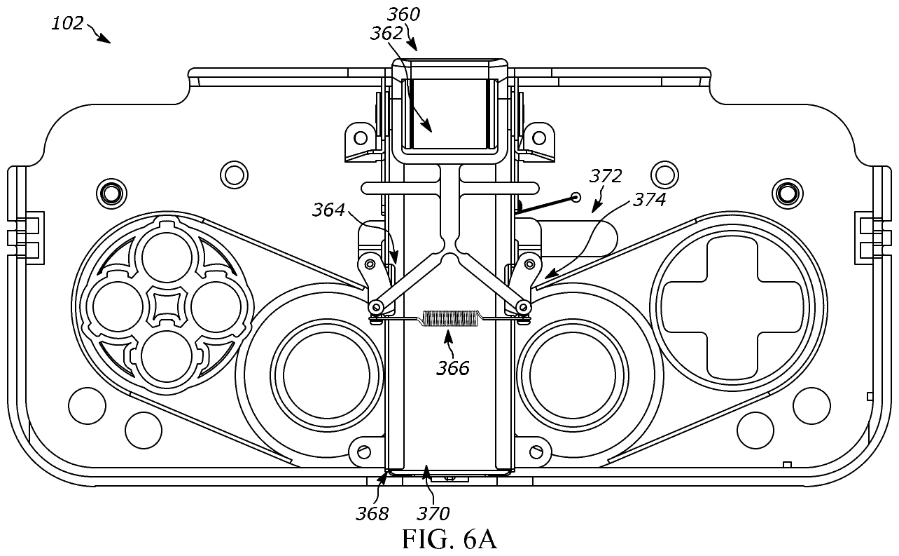

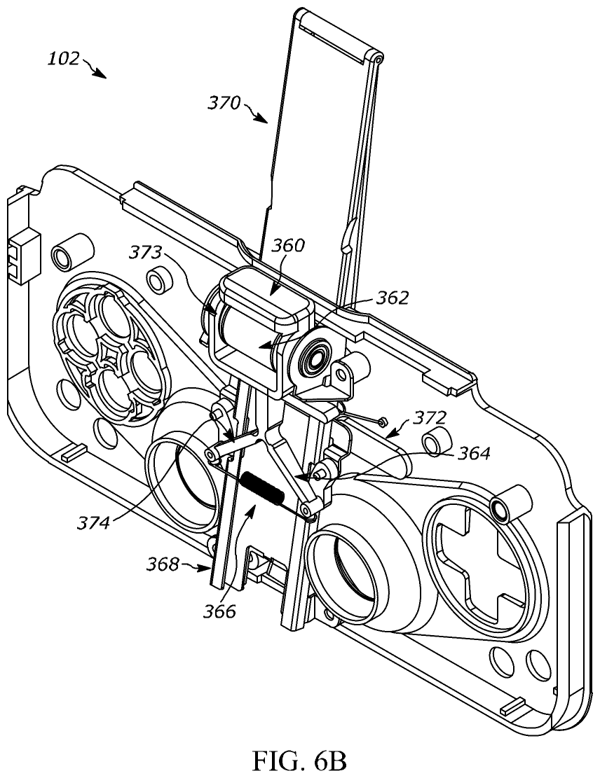

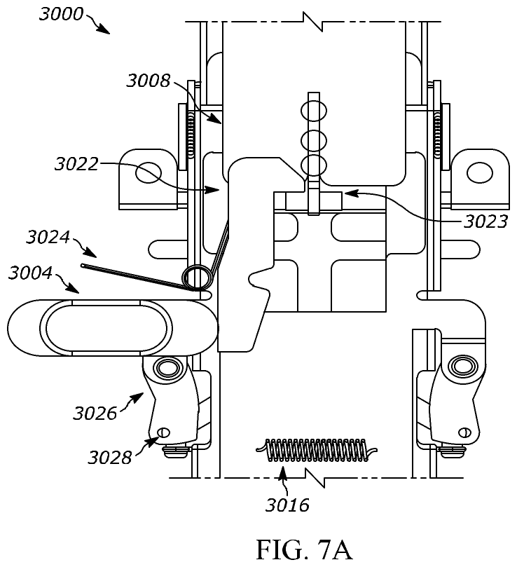

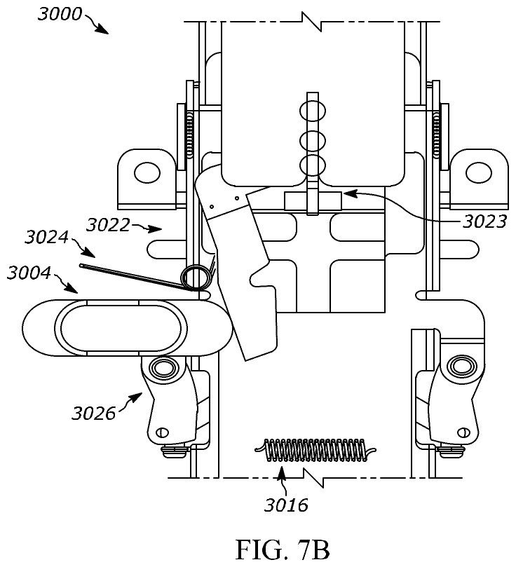

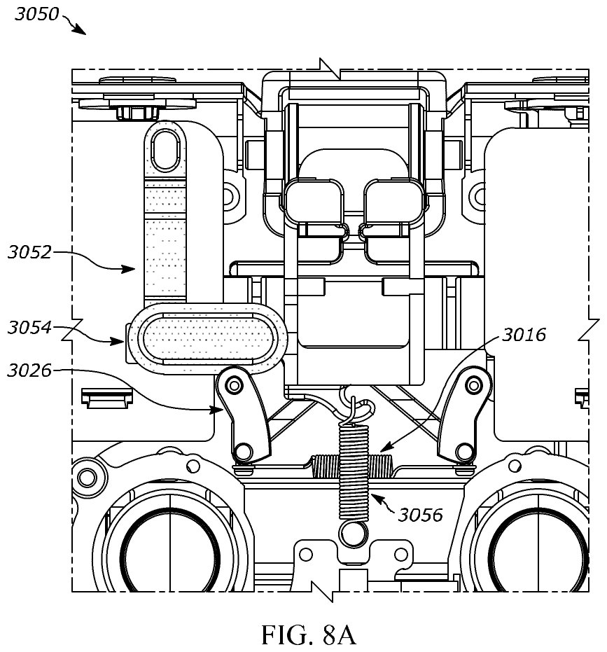

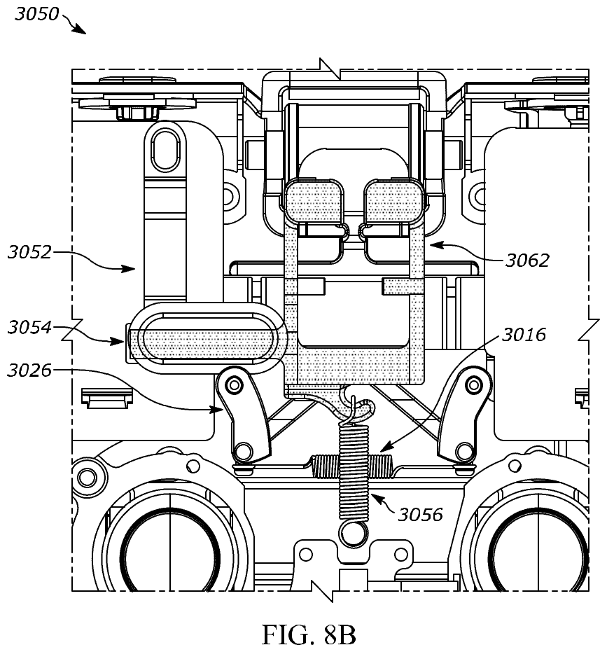

In particular embodiments, the lower-case element 102 additionally includes a sliding latch 356 and a launch button 360. The sliding latch 356, which will be described in more detail below with regards to FIGS. 7A-8B, is provided to prevent the slider 370 and/or upper-case element 106 from being accidentally removed from the lower-case element 102 when the launch button 360 is pressed. By pressing the launch button 360, energy from one or more constant force springs 362 is applied to the slider 370. This allows the slider 370 to move from a closed position inside the lower-case element 102, as shown in FIG. 6A to an expanded position where the slider 370 is outside of the lower-case element 102, as shown in FIG. 6B.

In particular embodiments, the lower-case element 102 includes a mechanism for holding and releasing the slider 370. The slider 370 is held in rails 368, which are configured to hold and control the motion of the slider 370 when the launch button 360 is pressed. Living hinges 364 are connected through sliding rail latches 374 to the rails 368. When a user wishes to release the slider 370 from the lower-case element 102, the launch button 360 may be pressed to cause the living hinges 364 to open and pivot the sliding rail latches 374 such that they are positioned in a way that they no longer prevent the slider 370 from exiting the lower-case element 102.

In particular embodiments, a spring 366 may be provided. The spring 366 may take any form, such as, for example, a tension spring that stores energy so that when the launch button 360 is released, the living hinges 364 and sliding rail laches 374 may be assisted in returning to their closed position. The spring 366, along with the living hinges 364 and sliding rail latches 374, may be situated such that energy is stored by the spring 366 either when the launch button 360 is pressed or when the launch button 360 is released, depending on specific design considerations. The spring 366 may take any other form than those shown and described without departing from the disclosure and is not limited to a tension spring.

As shown in FIGS. 6A and 6B, the slider 370 slides in a channel formed by the rails 368 when the launch button 360 is pressed. When the launch button 360 is pressed, the sliding rail latches 374 may be released, allowing the constant force spring 362 to extend the slider 370 out of the lower-case element 102. The constant force spring 362 may be mounted with bushings and bearings 373 that support a central pin on which the constant force spring 362 rotates. As the constant force spring 362 unrolls, it provides a constant force to cause the slider 370 to be moved out of the lower-case element 102.

In particular embodiments, if the sliding latch 372 is in a second position, the constant force spring 362 will provide enough force to allow the slider 370 and/or the associated upper-case element 106 to be removed from the attachable accessory 300. If, however, the sliding latch 372 is in its initial first position, the constant force spring 362 will cause the slider 370 to extend to a predetermined length outside of the lower-case element 102, but the slider 370 will not be allowed to move to a position that allows for detachment of the slider 370 and/or upper-case element 106 from the attachable accessory 300. The predetermined length may be any length that places the upper-case element 106 and any attached mobile electronic device 104 in an appropriate position for convenient use of the attachable accessory 300 and attached mobile electronic device 104 for such activities as gameplay, communication, video watching, or any other use.

FIGS. 7A and 7B show a particular embodiment of the latching mechanism 3000 of the sliding latch 372, 3004 that is used to prevent the slider 370, 3008 in FIG. 7A and allow the slider 370, 3008 in FIG. 7B to release the upper-case element 106 from the lower-case element 102. The sliding latch 3004 actuates a latch 3022 that prevents the slider 3008 and/or upper-case element 106 from being detached from the lower-case element 102. When the sliding latch 3004 is in a first position, the latch 3022 is caused to engage a protrusion 3023 on the bottom of the slider 3008. When the slider 3008 is caused to extend the predetermined length by the constant force spring 362, this protrusion 3023 is engaged by the latch 3022, preventing the slider 3008 from continuing to move out of the lower-case element 102.

In particular embodiments, the latch 3022 is attached to the sliding latch 3004 and a torsion spring 3024. While the one or more embodiments of FIGS. 7A and 7B show the torsion spring 3024; the torsion spring 3024 may be removed, or a different type of spring or mechanism may be used without departing from the disclosure. When a user wishes to remove the upper-case element 106 and/or slider 3008, the user moves the sliding latch 3004 to the second position, which causes the latch 3022 to disengage from the protrusion 3023 on the bottom of the slider 3008. This allows the slider 3008 to be removed either by the force of the constant force spring 362 as described above, or by a user.

In particular embodiments, the user presses the launch button 360, which causes the spring 3016 to cause the sliding rail latches 3026 to pivot on a pin 3028, releasing the slider 3008 to travel out of the lower-case element 102. Once the user releases the sliding latch 3004 or inserts the removed slider 3008 back into the lower-case element, the torsion spring 3024 exerts a force on the latch 3022, causing it and the sliding latch 3022 to return to the first position as shown in FIG. 7A, when the user releases or moves the sliding latch 3004 to the first position.

FIGS. 8A and 8B show a different configuration of the latching mechanism 3050. FIGS. 8A and 8B show a particular embodiment of the latching mechanism 3050. The sliding latch 3004 of FIGS. 7A and 7B is replaced with a phone plate release button 3054. The phone plate release button 3054 is pivotally attached by arm 3052 to the lower-case element 102. When the phone plate release button 3054 is pressed, it causes a latch 3062 to pull on one or more dampening springs 3056 as well as release the slider 3008 to travel out of the lower-case element. The one or more dampening springs 3056 provide a force to restore the phone plate release button 3054 after a user releases it. The dampening spring 3056 may also work to absorb energy from the constant force spring 362 when the slider 3008 is released by the launch button 360.

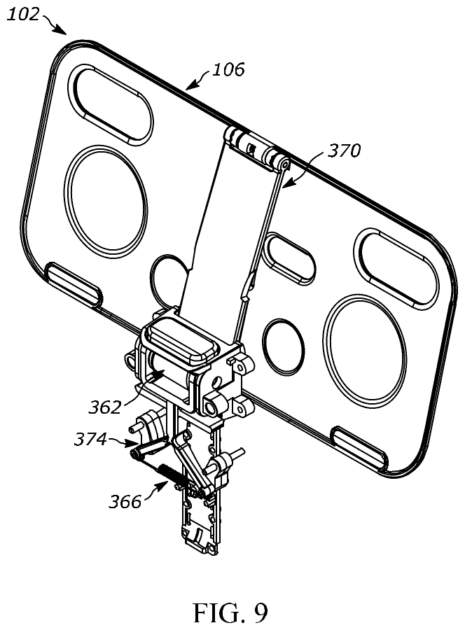

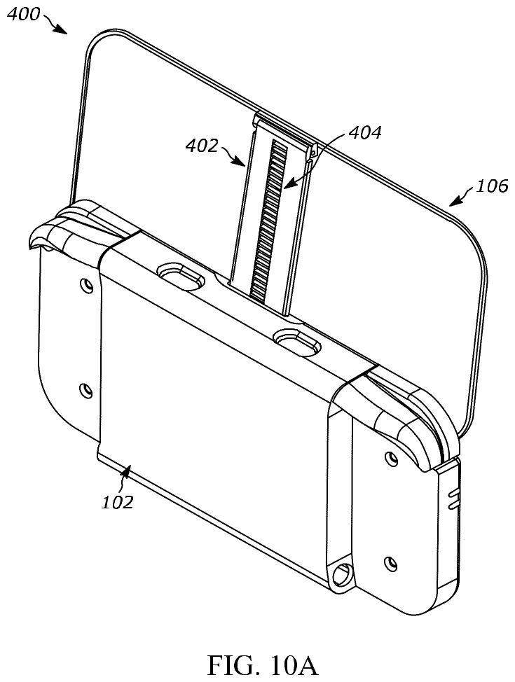

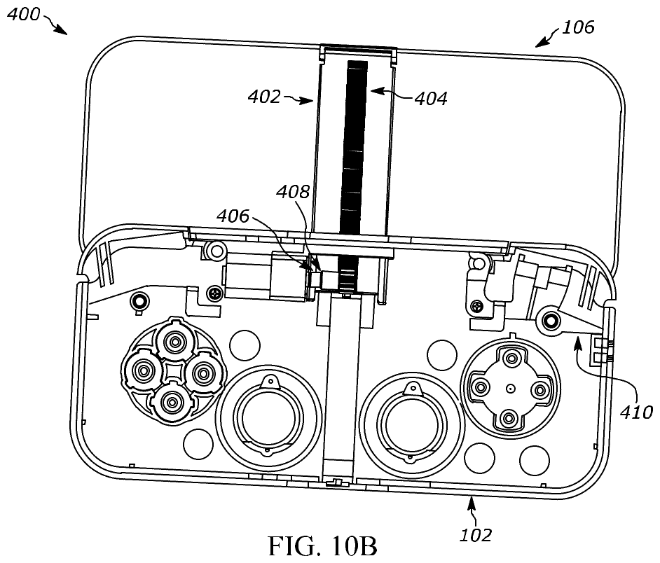

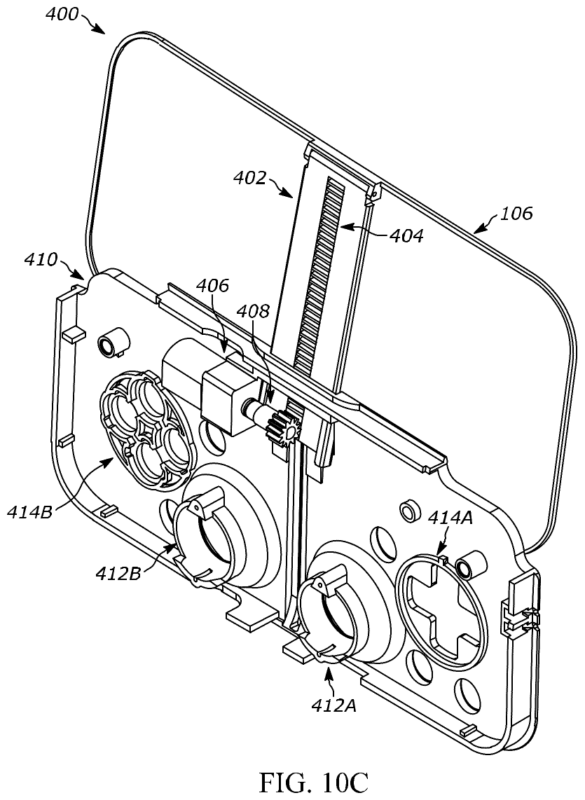

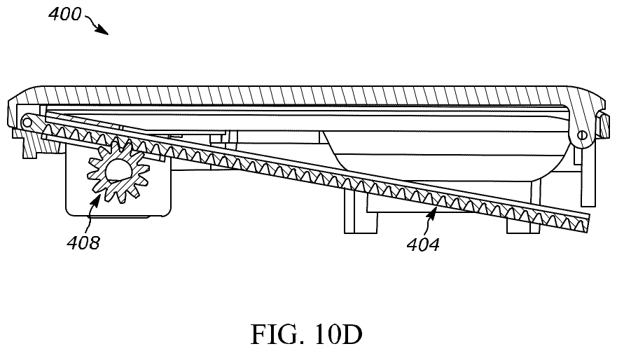

FIG. 9 shows the latching mechanism 3000 of particular embodiments connected to the upper-case element 106 with other components of the lower-case element 102 removed. As shown, the latching mechanism includes the constant force spring 362, the sliding rail latches 374, and the spring 366 in combination with a slider that attaches to the upper-case element 106. The constant force spring 362 may be made of any material, such as, for example, in a non-limiting example, steel. The material may be selected, as well as the design of the spring, to ensure that there is sufficient force to cause the slider 370 along with the rest of the upper-case element 106 when supporting a mobile electronic device 104, to be pushed to a full extension such as to the predetermined length and/or for removal of the slider 370, upper-case element 106, and/or mobile electronic device 104. The design and material of the constant force spring 362 may also be chosen so that the slider 370 is not expelled with sufficient force to damage the mobile electronic device 104 or cause potential injury to a user of the attachable accessory 300 and/or mobile electronic device 104. Alternatively, the constant for spring 362 may be replaced with a different kind of spring, or the slider 370 may be moved by a human without the aid of a spring. In a particular embodiment described in more detail below with regard to FIGS. 10A-12C, the slider 370 is moved by the aid of an actuator or electric motor. As an example and not by way of limitation, the motor may be a rack and pinion motor, or it may turn a threaded rod attached to the upper-case element and/or slider. The actuator or electric motor may be disposed in either the lower-case element or the upper-case element (or a combination thereof), and may be operable to cause the upper-case element and lower-case element to move relative to each other between the closed position and the expanded position.

In particular embodiments, as shown in FIGS. 10A-10D, the opening mechanism uses an actuator or electrical motor 406. As shown in FIG. 10A, the attachable accessory 400 with an electric motor includes a slider 402 with a rack 404 that a motor 406 moves a pinion gear 408 along. While the rack 404 is shown to be only in a portion of the slider 402, the rack 404 may be of any size and width. The rack 404 comprises a plurality of grooves that mate with the teeth of the pinion gear 408. When a user presses an appropriate button, such as 360 described above with regards to FIG. 5 and FIG. 6A or another launch button, such as launch buttons 350A or 350B shown in FIG. 4A, the motor 406 causes the pinion gear 408 to move up or down the rack 404, causing the upper-case element 106 to move relative to the lower-case element 102 to the expanded position as shown in FIG. 1B or to the closed compact position as shown in FIG. 1A.

As shown in FIG. 10B and FIG. 10C, the motor 406 and pinion gear 408 may be mounted on the underside of a top portion 410 of the lower-case element 102. This top portion additionally includes a left opening 414A and a right opening 414B configured to expose one or more input interfaces. The top portion may also include a left circular recess opening 412A and right circular recess opening 412B configured for a joystick or analog control. As shown in FIG. 10C, at least the left circular recess opening 412A and right circular recess opening 412B are significantly recessed, giving protection to the analog control or joysticks and/or any other input interfaces when the attachable accessory 100 is in the closed position. Additional components may be provided on the top portion, including switches, displays, and other user input interfaces that allow a user to interact with an attached mobile electronic device 104.

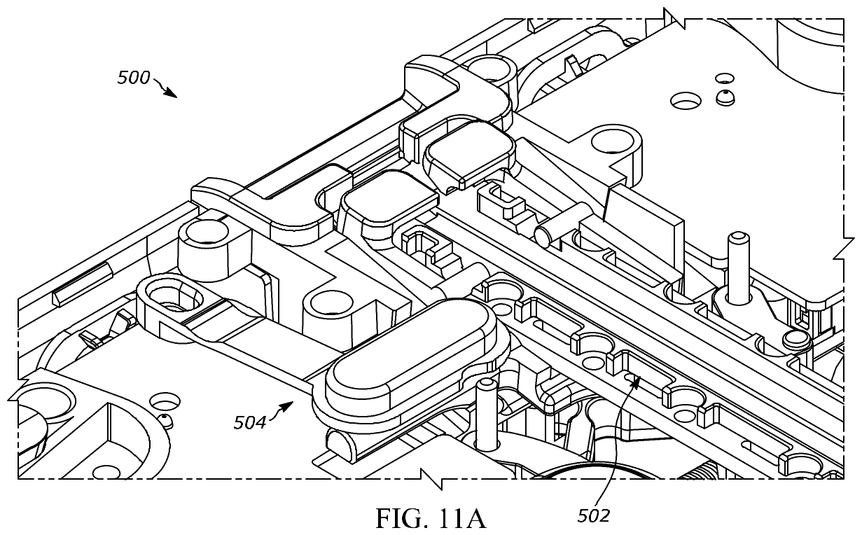

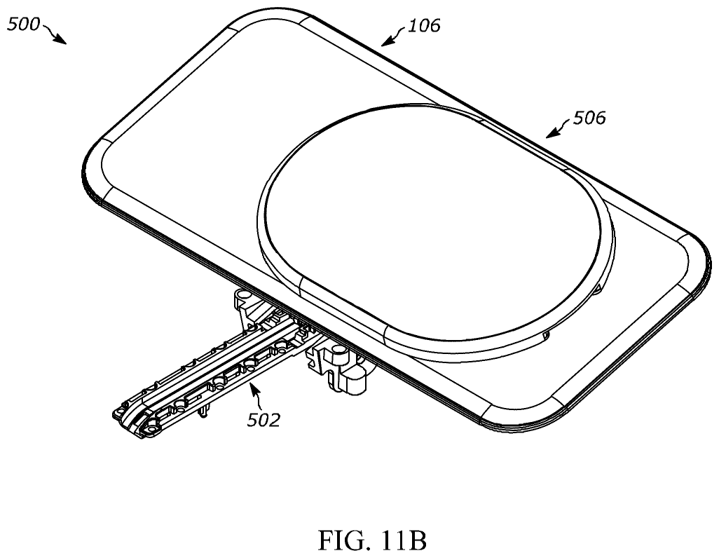

In particular embodiments, as shown in FIG. 11A, the sliding rails 314 are covered by an optional rail cover 502. This rail cover 502 allows for a top surface of the lower-case element 102 to be removably attached to a lower portion of the lower-case element 102 using screws or other types of fasteners that may easily be removed. The top surface may comprise one part or multiple parts joined in a seam over the rail cover 502. As shown in FIG. 11B, when the fasteners are removed, the upper components 500 of the attachable accessory 100 may be removed. This allows a user or technician to easily repair or replace the components of the attachable accessory 100, such as the mechanisms that button 504 interacts with, in order to allow the slider 370 to be removable as discussed previously. As an example and not by way of limitation, a user may need to replace the spring 366 or the entire launch mechanism.

In particular embodiments, as shown in FIG. 11B, the rail cover 502 may be associated with the upper-case element 106. The upper-case element 106 may include a puck 506 for attaching the mobile electronic device 104 to the attachable accessory 100. As will be described in more detail below with regard to FIGS. 20A-26C, the puck 506 may include one or more magnets and/or compliant material that is deformable and able to provide a friction fit when the mobile electronic device 104 is placed on the top surface of the puck 506. When a user presses a button 504, the upper-case element 106, along with puck 506, may be allowed to slide out of the lower-case element 102.

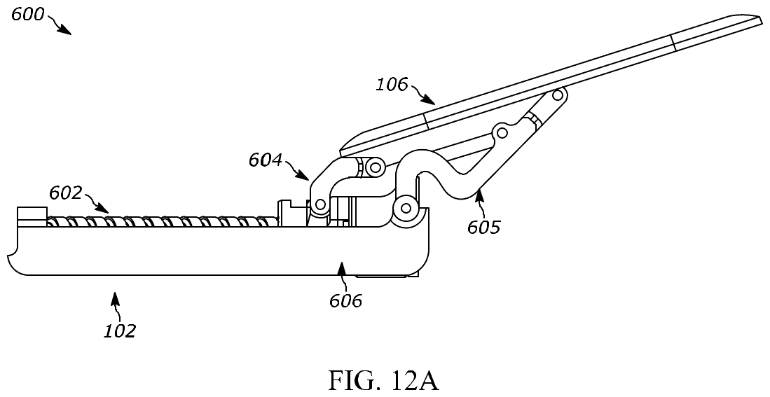

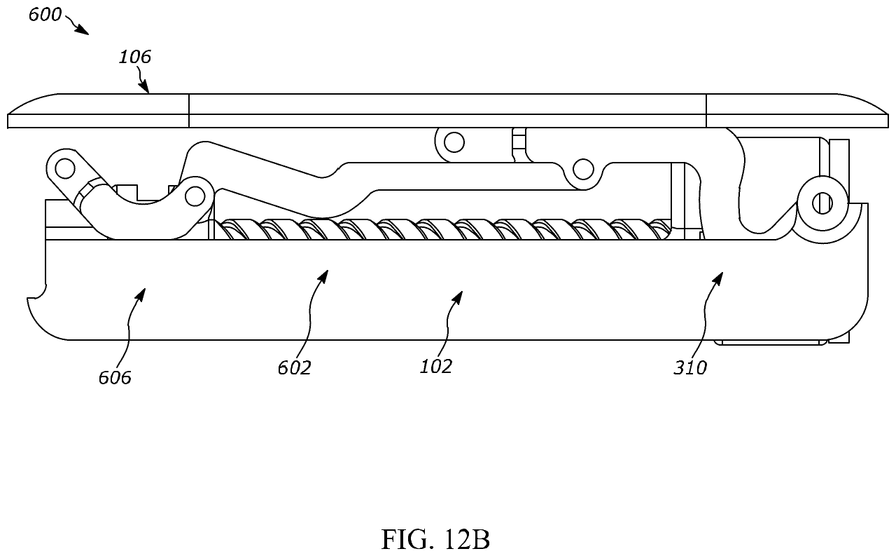

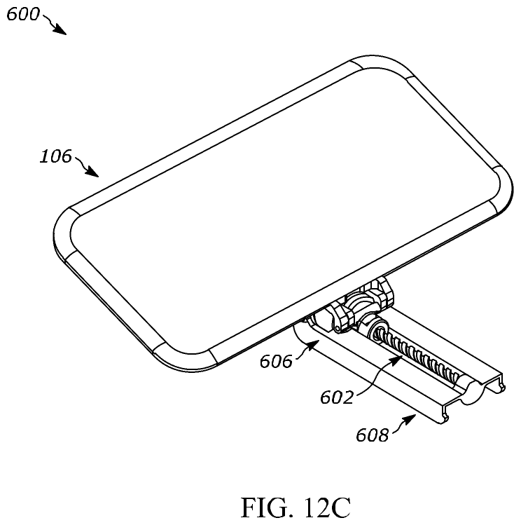

In particular embodiments, as shown in FIGS. 12A-12C, instead of the rack 404 that is moved by a pinion gear 408, the opening mechanism 600 may comprise a motor 606 that moves along a threaded rod 602. A mechanized slide mechanism 608 that moves the upper-case element 106 from a closed position, as shown in FIG. 12B to an expanded (open) position, as shown in FIG. 12A. The slide mechanism 608 may be inserted into the rails 368 in the lower-case element 102. The slide mechanism 608 may take the place of the slider 370 or similar components shown in previous figures. The slide mechanism 608 includes a motor 606, which moves along a threaded rod 602 and causes one or more arms, for example, the first arm 604 and the second arm 605, to extend. While two arms are shown, only one arm 605 may be needed, or more than two arms may be used. Extending the first arm 604 and second arm 605 causes the upper-case element 106 to move from a closed position where the upper-case element 106 is parallel to the lower-case element 102, and where a top portion of the lower-case element 102 is substantially covered by the upper-case element 106 as shown in FIG. 12B to an extended position, as shown in FIG. 12A. As shown in FIG. 12C, in particular embodiments, the upper-case element 106, along with the slide mechanism 608, may be removable from the lower-case element 102.

The motors 406 and 606 may take any form, including, for example, a stepper or brushless motor. The motors 406 and 606, as described above, may use a pinion gear 408, a threaded rod 602 to move, or they may directly actuate arms 604 and 605. The motors 406 and 606 may lock in place when in the expanded position, as shown in, for example, FIG. 12A or alternatively, the motors 406 and 606 along with their corresponding slide mechanism 608 may include a clutch that allows a user to be able to manually put the upper-case element 106 in a closed position, as shown, for example, in FIG. 12B, when battery power has been exhausted, or the mobile electronic device 104 is detached. The disclosure is not limited to the motors 406 and 606, constant force spring 362, or other actuators described above, and the opening mechanism may take any form without departing from the disclosure.

In a particular embodiment, the motors 406 and 606 may be controlled by a user via one or more interactive elements. As an example and not by way of limitation, the user may press a button or other actuator on the attachable accessory 100, which causes the upper-case element 106 to move to the expanded position. Additionally, in particular embodiments, the motors 406 and 606 may be controlled by a controller, which may determine where to position the upper-case element 106 based on the particular type of mobile electronic device 104. In a particular embodiment, the motors 406 and 606 may variably position the upper-case element 106 based on instructions received from a particular application or game being played on or executed by the attached mobile electronic device 104 or based on signals received from gyroscopic devices in either the attached mobile electronic device 104 or the attachable accessory 100. The motor, e.g., 606, may adjust one of the arms 604 and 605 to obtain a desired angle. This may allow a user to tilt the attachable accessory 100 while playing or using the attachable accessory 100, with the motor, e.g., 606, maintaining the screen of the mobile electronic device 104 in a similar position relative to the user's eyes.

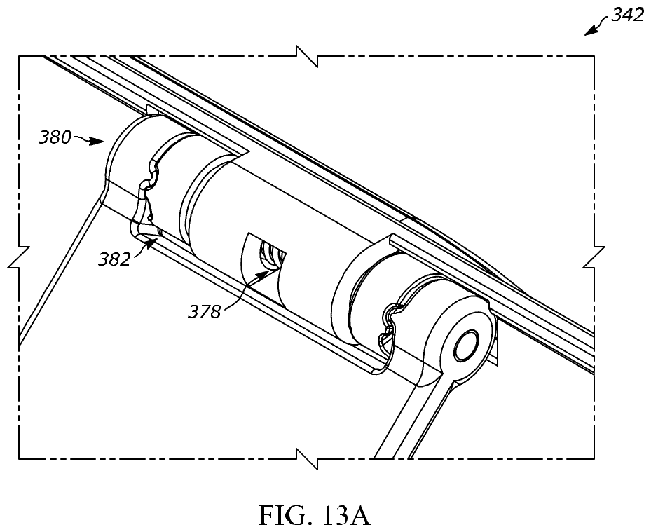

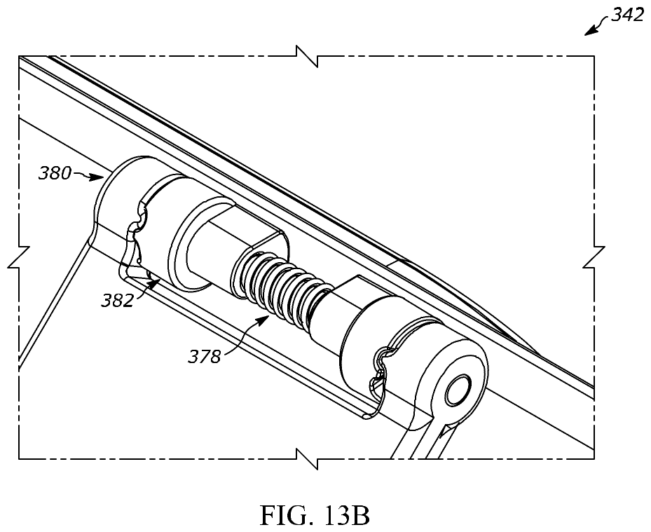

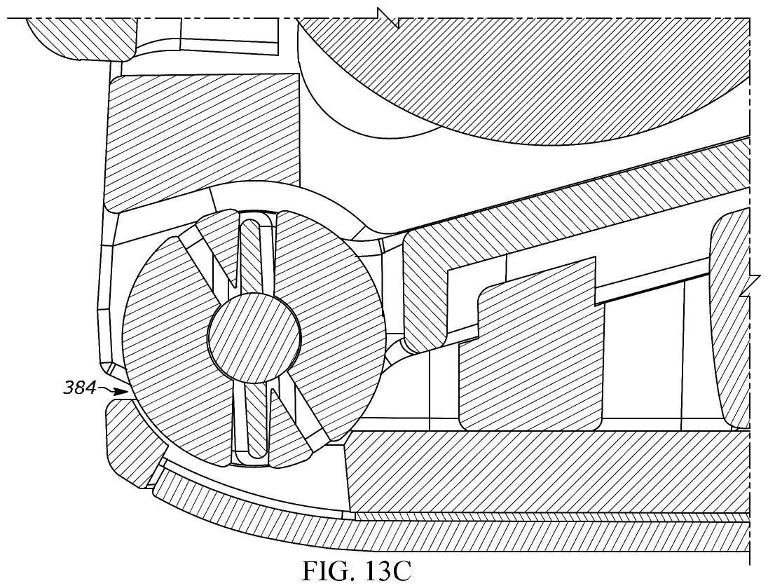

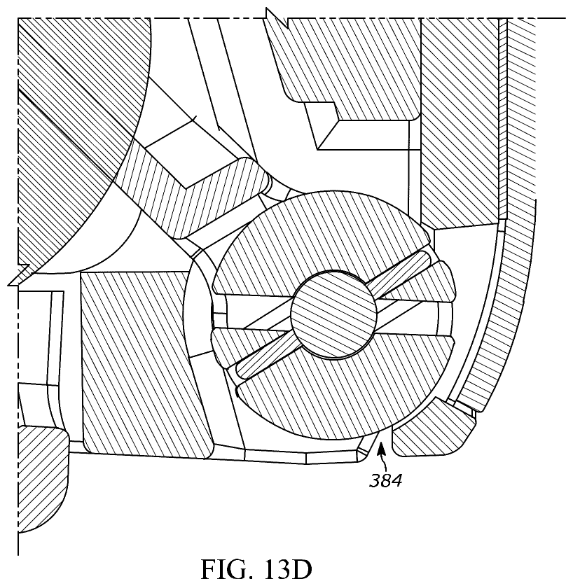

In particular embodiments, the upper-case element 106 is attached to the slider 370 with a compression spring 378, loaded pivot 380 as shown in FIGS. 13A-13D. The pivot, in combination with the compression spring 378, provides a holding force and at least two detent positions. For example, the pivot may allow the upper-case element 106 to rotate to a zero-degree position to a thirty-degree position; other positions may be obtainable, including acute angles such as ninety, twenty, forty-five, or obtuse angles such as one hundred twenty degrees.

In particular embodiments, the compression spring 378 provides tension or outward force to a detent mechanism 382. The detent mechanism 382 includes an insert 384 that has two or more slots, which determine the detent positions. A first position as shown in FIG. 13C may correspond to the zero-degree position, and a second position may correspond to a second position, as shown in FIG. 13D may correspond to a second angle, such as, but not limited to, thirty degrees.

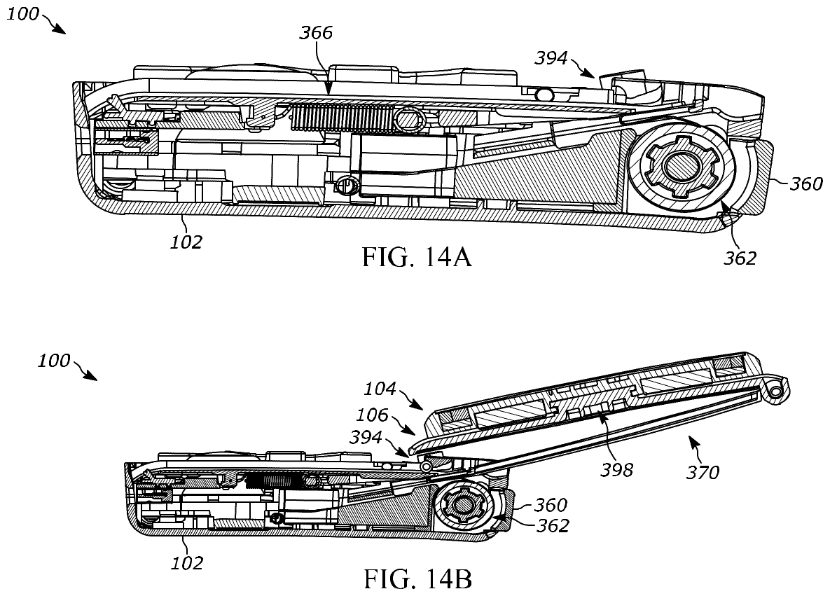

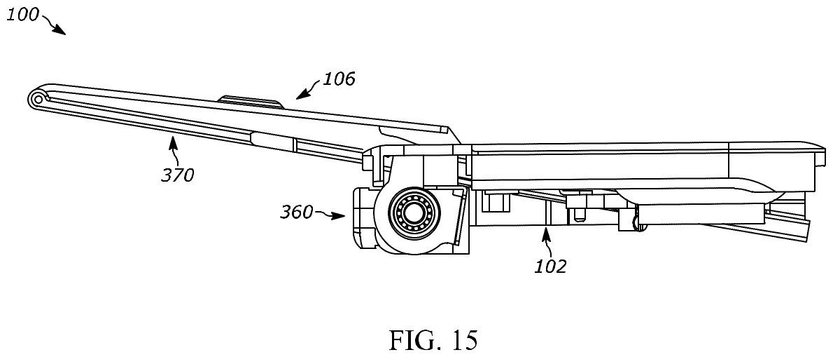

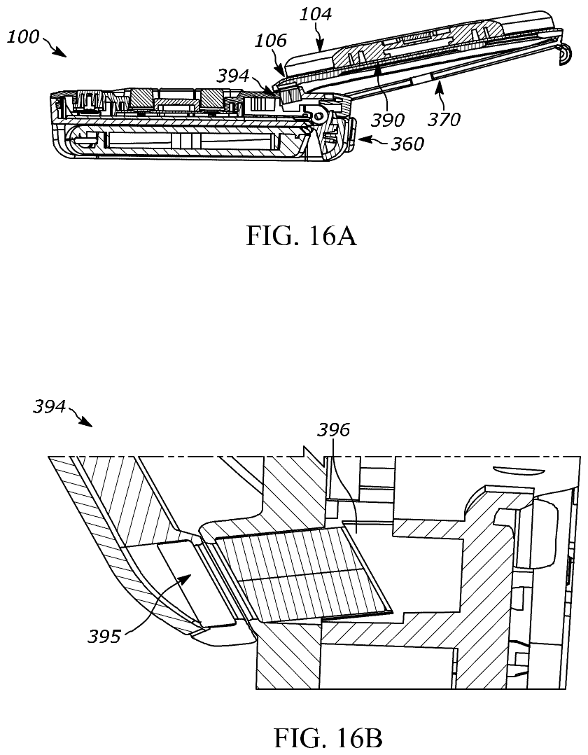

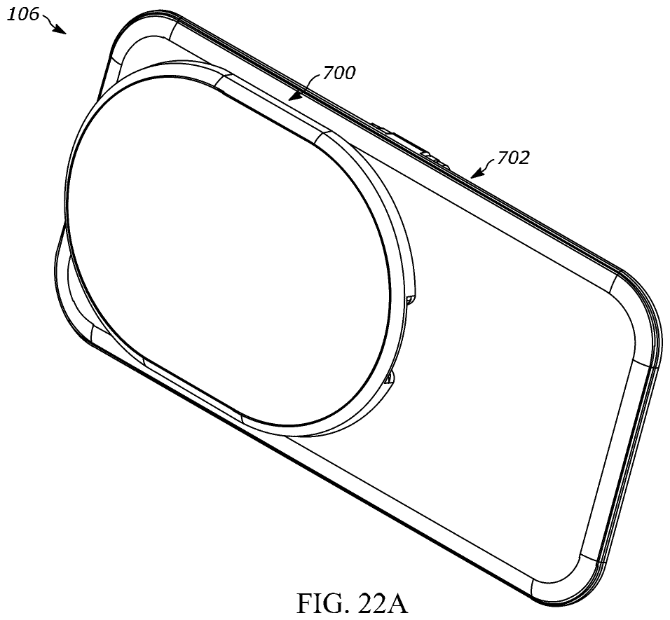

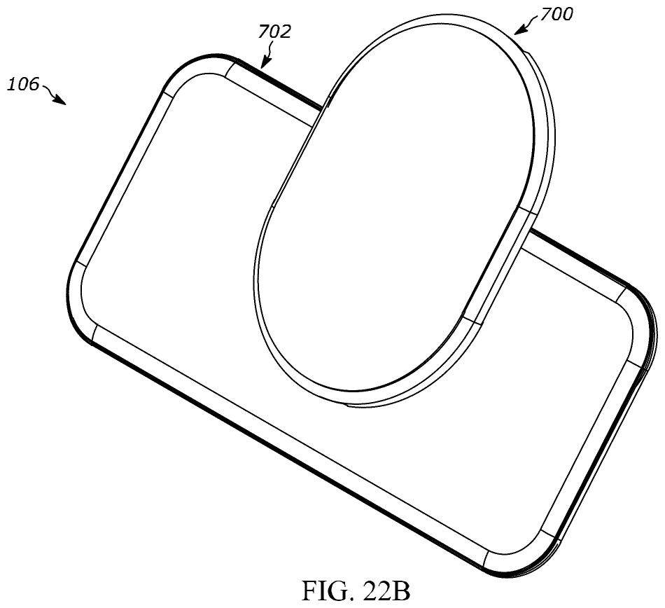

In particular embodiments, shown in FIGS. 14A-18C, the upper-case element 106 is detachable from the lower-case element 102. FIG. 14A shows the lower-case element 102 when the upper-case element 106 is detached. FIGS. 14B and 15 show the attachable accessory 100 with the upper-case element 106 at a first expanded position, with the puck 506 attached, e.g., FIG. 14B, and detached, e.g., FIG. 15. The detachable attachable accessory 100 of FIGS. 14A and 14B include a constant force spring 362 and a spring 366. The upper-case element 106 includes a shoe 398 that the attached mobile electronic device 104 may use to communicate power and data between the mobile electronic device and the attachable accessory 100. As shown in FIG. 16A the upper-case element 106 includes an attachment component 390 such as, but not limited to, the puck 700 described below with regards to FIGS. 22A-26C. The attachment component 390 may include the shoe 398 or any other component allowing the mobile electronic device 104 to attach and connect to the attachable accessory 100.

In particular embodiments, as shown in FIGS. 16A and 16B, the attachable accessory 100 may include one or more stabilizing magnets 394 in the upper-case element 106 and lower-case element 102. As shown in more detail in FIG. 16B, the stabilizing magnets 394 comprise a first set of magnets 396 that are part of the lower-case element 102, which magnetically couple with a second set of magnets 395 that are part of the upper-case element 106. While shown at or about one end of the upper-case element 106 in FIG. 16A, the stabilizing magnets 394 may be in any place along either the upper-case element 106 or the lower-case element 102. In particular, embodiments these magnets prevent the upper-case element 106 from wobbling or shaking, providing more stability.

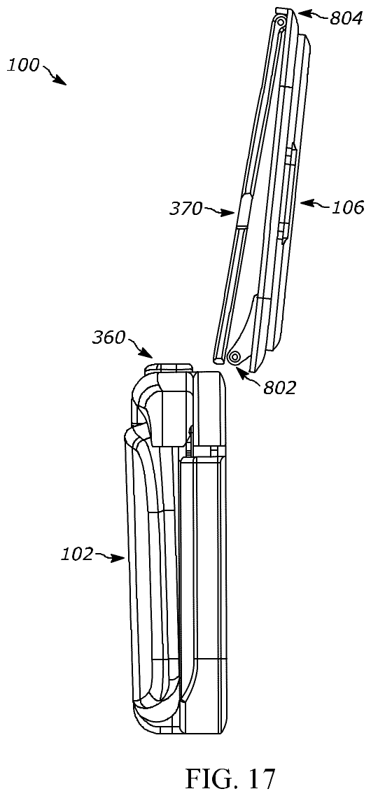

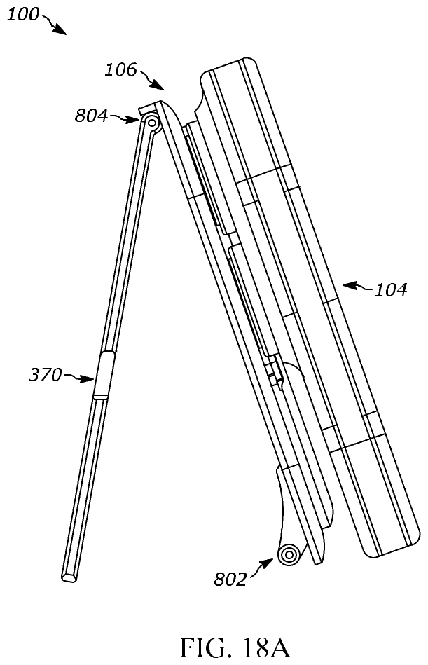

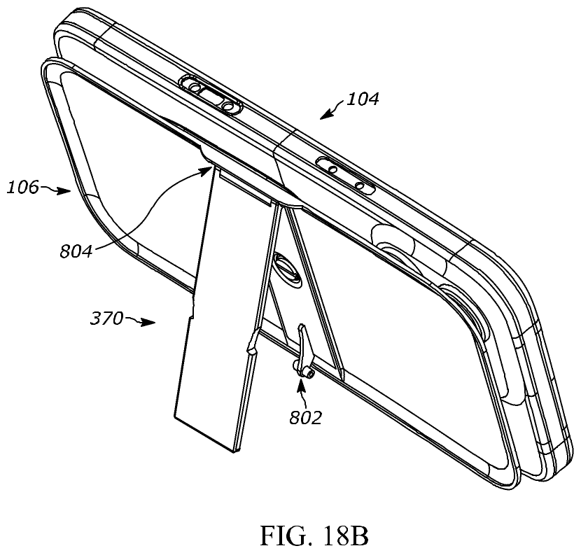

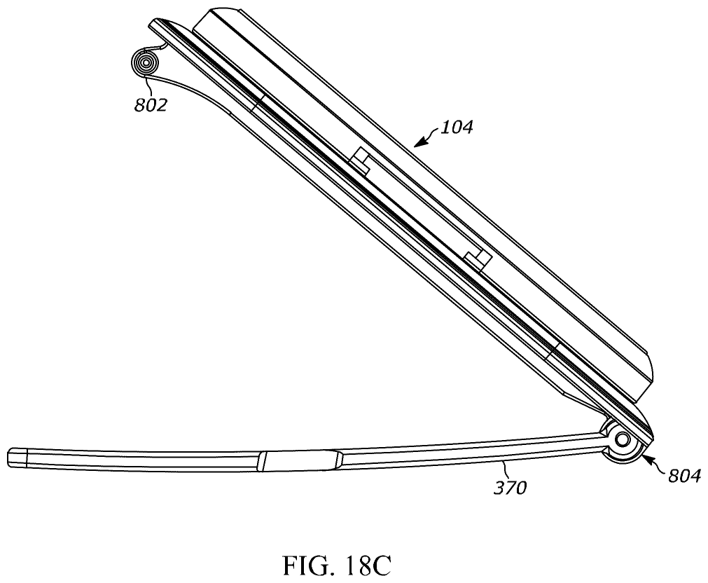

In particular embodiments, as shown in FIG. 17, FIG. 18A, FIG. 18B, and FIG. 18C, the upper-case element 106 is detached from the lower-case element 102. In particular embodiments, the upper-case element 106 includes a pivot 804 and a plate pin 802. The pivot 804 allows for the slider 370 to serve as a standalone kick stand and support the upper-case element 106 on a surface when a mobile electronic device 104 is attached. This allows a user to use the upper-case element 106 to hold the mobile electronic device 104 in a convenient manner, separated from the lower-case element 102. For example, in a non-limiting example, a user may place the upper-case element 106 along with the attached mobile electronic device 104 on a table, either to watch or view images on the mobile electronic device 104 or to play games on the detached lower-case element 102. The lower-case element 102 may communicate with either or both the upper-case element 106 and the mobile electronic device 104.

The pivot 804 allows the slider and the upper-case element 106 to be placed at any stable angle relative to each other. With the assistance of the plate pin 802, the upper-case element 106 may be held at any stable position. In particular embodiments, the pivot 804 may be similar to or the same as pivot 380 and include a detent mechanism 382 to restrict the slider 370 acting as a standalone kickstand to particular angles and positions. The disclosure is not limited to the user of the plate pin 802 and particular pivots 380. While shown in FIG. 18B holding the mobile electronic device 104 in a landscape mode, the slider 370 and plate pin 802 may be positioned to hold the mobile electronic device stable in a portrait mode or any other desired orientation without departing from the disclosure.

In particular embodiments, the slider 370 may function as a standalone kickstand as described above. As an example and not by way of limitation, the slider 370 may be placed on a surface of the ground or a table, parallel to the surface of the ground or table; and when place this way the upper-case element 106 may be held by the detent mechanism 382 at an angle to the surface, with the slider supporting the upper-case element 106 and the attached mobile electronic device 104.

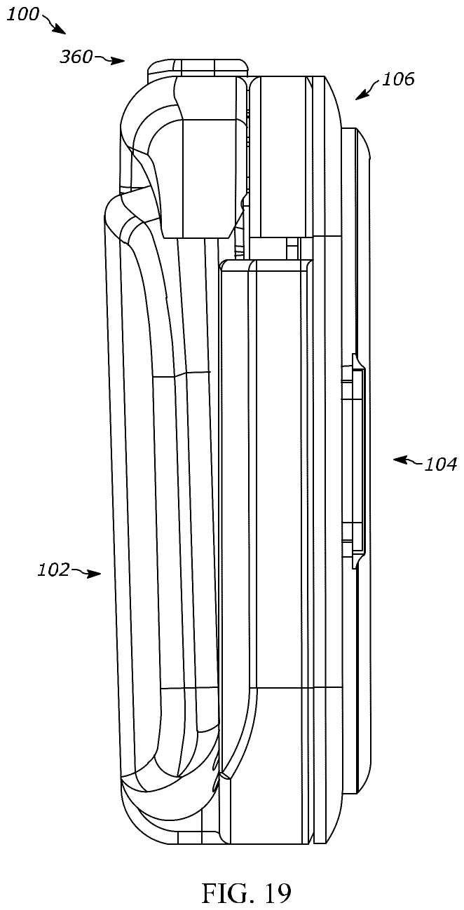

In particular embodiments, the slider 370 is designed to be easily re-inserted into lower-case element 102 to return the attachable accessory 100 to the closed compact position as shown for example in FIG. 19. The slider 370 may have a sloped or curved shape so that when a user presses the launch button 360, the upper-case element moves in both a direction away (or parallel) to the lower-case element 102 and transverse (or vertical) to the lower-case element 102. This potentially prevents the slider 370 and upper-case element from pinching or otherwise injuring a user's hands or fingers when the launch button 360 or other buttons on the back of the lower-case element 102 are pressed.

### Adjustable Magnetic Puck

In particular embodiments, as shown in FIGS. 20A and 20B, the attachable accessory, e.g., 100 or 300, includes a puck 320 that is configured to removably attach the mobile electronic device 104 to the attachable accessory 300. The puck may include magnets or other components for attaching the mobile electronic device 104 to the attachable accessory 300. This may include magnetically coupling to a magnetic component (e.g., a MAGSFE ring) with different mobile electronic devices 104, such as, but not limited to, a mobile phone as shown in FIG. 21. More information on magnetic coupling of accessories to mobile electronic devices may be found in U.S. patent application Ser. No. 18/905,064, filed 2 Oct. 2024, which is incorporated by reference.

As shown in FIG. 21, mobile electronic devices 104 may take the form of a mobile phone, including any smartphone such as an iphone, Android phone, or any other type of phone. The mobile electronic device 104 may include a particular surface 114, such as the back side or reverse side of the phone. The camera bump 116, which has one or more cameras 112 (specifically their lenses), may be positioned on the particular surface 114 of the mobile electronic device 104. That mobile electronic device 104 may additionally include a MAGSAFE ring 118 as well as third-party grips, handles, or other components 117. Additionally, the components such as the MAGSAFE ring 118 and camera bump 116 may be at different locations, have different shapes, or be in different orientations than that shown in FIG. 21. The specific mobile electronic device 104 shown in FIG. 21 is an example, and the disclosure is not limited by it.

To address these potential challenges associated with uncentered MAGSAFE rings 118 and/or camera bumps 116 being in different positions in different mobile electronic devices 104 and/or the configuration of mobile electronic devices' cases, particular embodiments are shown in FIGS. 22A-24 that provide for a movable puck 700 mounted on a top surface 702 of the upper-case element 106. The puck 700 is movable along a lateral axis from a first position to a second position parallel to the top surface of the upper-case element 106 and/or the mobile electronic device 104. As shown in FIG. 22B, the puck 700 may also be configured to rotate from the lateral axis to a perpendicular or other angle. In particular embodiments, the lateral axis is along a long direction of the mobile electronic device 104. The puck 700 may be configured to move in any direction or angle compared to the top surface 702, and the disclosure is not limited to the puck 700 moving in either or both a lateral direction and a rotational direction.

In particular embodiments, the puck 700 includes a magnetic component 708 that may conform to the MAGSAFE specification for easy magnetic attachment to MAGSAFE-compliant mobile electronic devices 104 such as IPHONE or other ring magnet array standards such as QI 2 WIRELESS CHARGING COMPATIBLE devices. By means of magnetic component 708 as well as the ability of the puck 700 to be moved both laterally and rotationally along a track 706, the puck 700 as well as the position of the upper-case element 106 relative to the mobile electronic device 104 may be adjusted, for example, to a centered or off-center location. This allows the attachable accessory 100 to be universally adaptable to different mobile device models (e.g., IPHONE, ANDROID, etc.) with varying magnetic positioning specifications, accommodating the centering variability so that when attached, the mobile electronic device 104 may always be centered on the attachable accessory 100 regardless of the magnetic electronic device's 106 magnet positions.

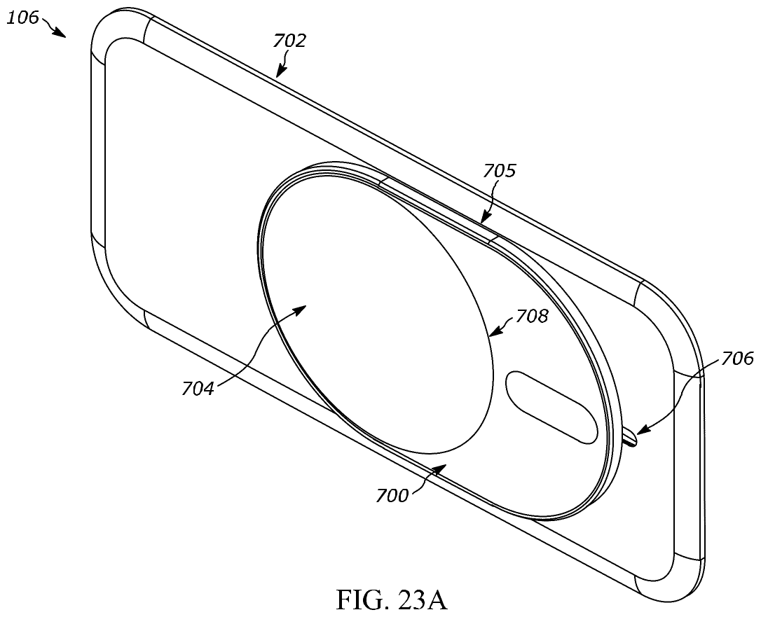

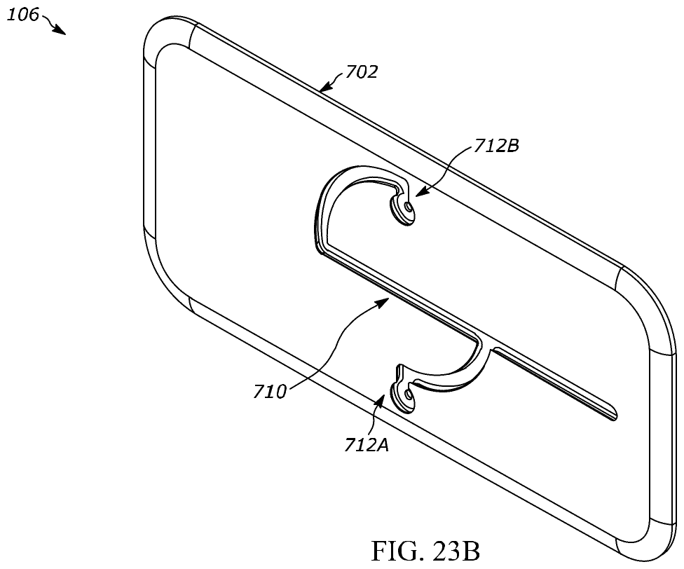

In particular embodiments, shown in FIG. 23A, one or more magnetic plates 705 may form the puck 700. The one or more magnetic plates 705 that form the puck 700 may be magnetically coupled together and stacked on the top surface 702 of the upper-case element 106 to achieve a desired height. This configuration may help adapt to the variations in the depth of the mobile electronic device 104. For example, as discussed, the mobile electronic device 104 may have a camera bump 116 protruding from its back surface or may be enclosed in a protective casing. By adjusting the height of the puck 700—for instance, by adding or removing one or more magnetic plates 705, a clearance may be provided to accommodate for the camera bump, the casing, or other possible protrusions on the back surface of the mobile device, allowing it to seat snugly on the top surface 702 of the upper-case element 106. In particular embodiments, this may eliminate the need for a camera cutout, such as the opening 319 discussed above with regards to FIG. 3B, although alternatively or additionally, one or more cutouts may be provided on the upper-case element 106 for additional clearance if desired.

The shape of the puck 700 may vary across embodiments. For example, although illustrated as circular, the puck 700 may alternatively be elliptical, rectangular, triangular, polygonal, non-polygonal, or irregular in shape, providing different physical appearances to suit user preferences. In particular embodiments, instead of a universally compatible upper-case element 106 and/or puck 700 may be customized to a specific mobile electronic device 104. As an example and not by way of limitation, the position of the puck 700 or the magnetic component 708 may be tailored to the specific magnetic configuration of the mobile electronic device 104. As an example and not by way of limitation, the upper-case element 106 may be provided with specific features such as a camera cutout (e.g., an opening with a particular shape and dimension), one or more surface contours, and other adaptations to accommodate specific mobile device models.

In particular embodiments, the upper-case element 106 may include a slot that forms a track 706 for the magnetic plate 705 to attach to and move on. This track 706 allows the magnetic puck 700 to pivot in multiple directions, allowing an attached mobile electronic device 104 to pivot from, for example, a portrait mode to a landscape mode. The puck 700 may include one or more pins 704 that are inserted into the track 706 and allow for secured movement about the slot. Generally, two pins, e.g., 704, are used. However, any number of pins, e.g., 704, may be inserted into the track 706. The pins 704 may also be designed to secure the puck 700 to the upper-case element 106.

The track 706 as shown in FIG. 23B in a particular embodiment includes a straight portion 710 and two or more curved portions 712A and 712B. The straight portion 710 allows the puck 700 to move vertically to center the specific mobile electronic device 104 relative to the upper surface 702 of the upper-case element 106, or to place the mobile electronic device 104 in a position that is preferable to a user. The curved portions 712A and 712B allow the puck 700 to rotate so that the mobile electronic device 104 may be pivoted from a portrait mode to a landscape mode or other desired orientation. While FIG. 23B shows a specific shape for the track 706; it may take any shape that provides a desired amount of rotation and positioning of the mobile electronic device 104. This may include more or less curved portions, e.g., 712A, a circular portion, additional linear portions, and/or any other portions.

In particular embodiments, the track 706 may include additional fasteners to secure the puck 700 or mobile electronic device 104 to the upper-case element 106 in a particular orientation. This may include fasteners that are on the opposite side of the upper-case element 106 from the puck 700; once a user is happy with the position of the puck 700 or mobile electronic device 104, the user may tighten or engage the fasteners to the pins 704 to ensure that the puck 700 does not move during use. These fasteners may take the form of screws, latches, or any other fasteners that may engage with pins 704. Alternatively, the fasteners may take other forms or may be part of the pins 704 themselves.

The pins 704 may take any form that releasably secures the puck 700 and/or attached mobile electronic device 104 to the upper-case element 106. The pins 704 may have a dovetail shape or may be a T joint. In a particular embodiment, the track 706 may be made of steel or other ferrous metal. The puck 700 may be made of magnetic material or include magnetic pins 704 that engage with the material of the track 706 through magnetism to releasably secure the magnetic puck 700 and/or mobile electronic device 104 to the upper-case element 106. The pins 704 may include threading or other modifications that allow them to be secured by the fasteners or other components to the upper-case element 106, in order to prevent unwanted movement of the puck 700.

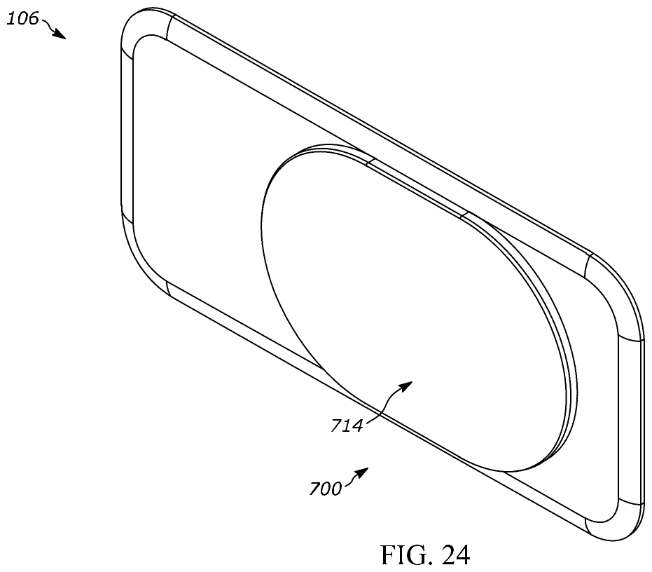

In a particular embodiment shown in FIG. 24, the puck 700 may be attached with a spring-loaded shoe 714. The spring-loaded shoe 714 allows the puck 700 to be more securely attached to the track 706, but in such a manner that a user may easily release it when they want to remove the puck 700 or mobile electronic device 104 attached to the upper-case element 106. The spring-loaded shoe 714 further allows the puck 700 to attach in various positions and orientations. As an example and not by way of limitation, the puck 700 may be attached in a landscape orientation or a portrait orientation.

In a particular embodiment, the spring-loaded shoe 714 may be a cold shoe or a hot shoe. The spring-loaded shoe 714 may be able to provide or receive electrical power and/or data from or to a connected mobile electronic device 104. The spring-loaded shoe 714 may channel power and data either from the attachable accessory 100 and/or a battery included in it to the attached mobile electronic device 104 and/or its battery. The spring-loaded shoe 714 may be connected to coils or copper traces in the puck 700 or elsewhere that are able to conduct electricity and/or transmit signals (e.g., to wirelessly transfer data or wirelessly transfer electrical power to or from the mobile electronic device). Additionally, the spring-loaded shoe 714 may be usable for other purposes, such as geolocation (for example, in a non-limiting example, a global positioning system (GPS)) or other location services. The spring-loaded shoe 714 may be configured in any manner or serve any purposes besides those just described, and the disclosure is not limited to those. More information on wireless power transfer between accessories and mobile electronic devices may be found in U.S. patent application Ser. No. 18/747,940, filed 19 Jun. 2024, and U.S. patent application Ser. No. 18/816,545, filed 27 Aug. 2024, each of which is incorporated by reference.

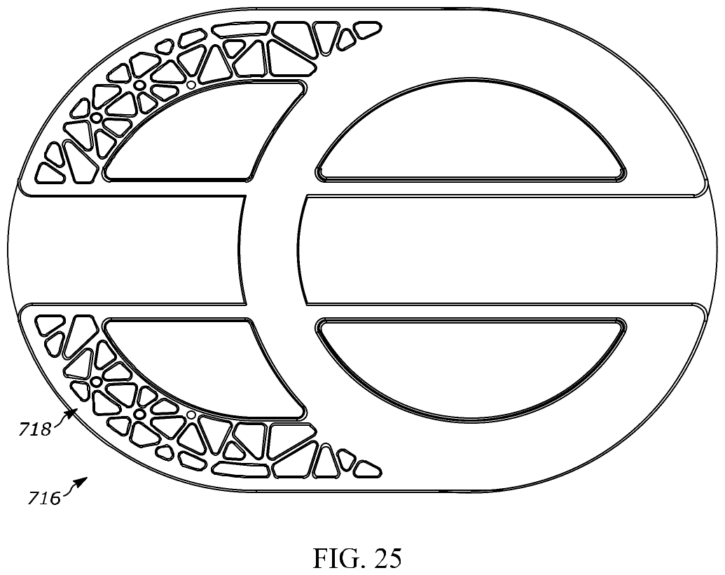

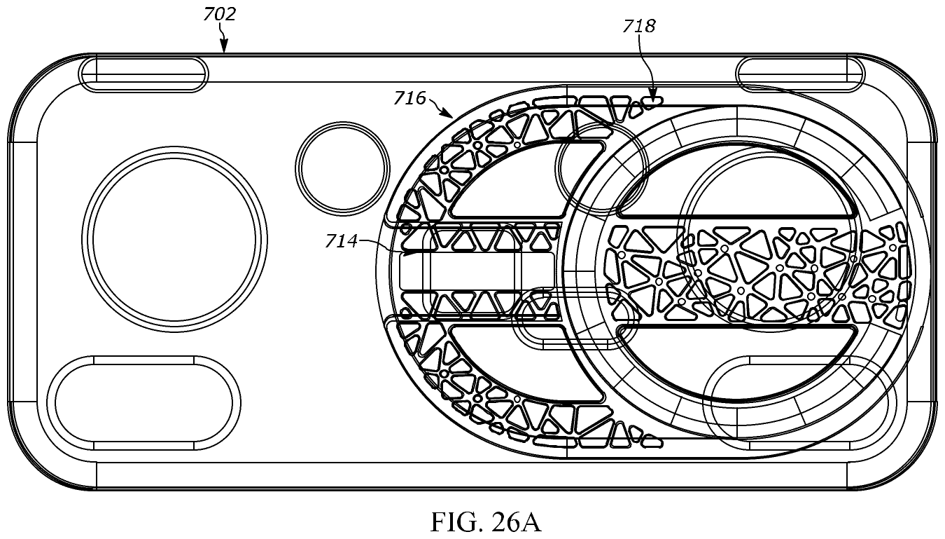

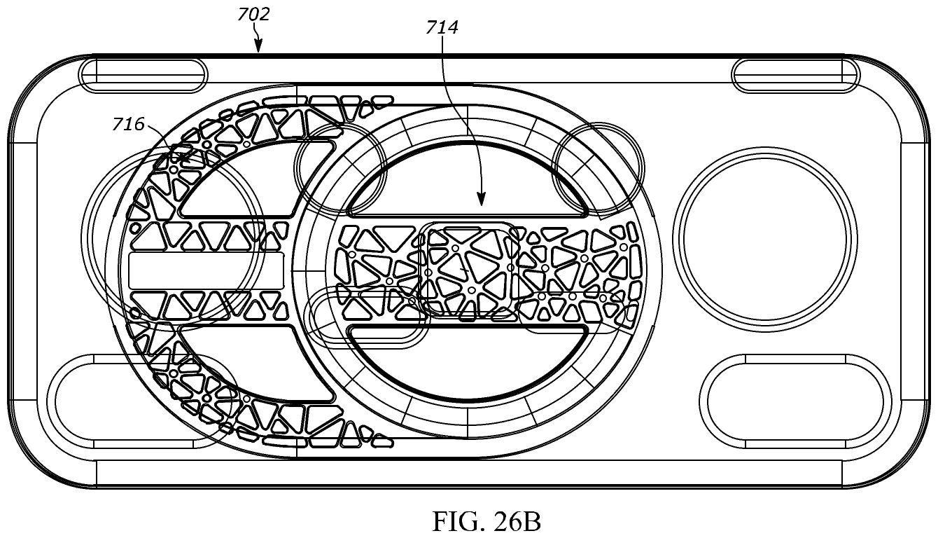

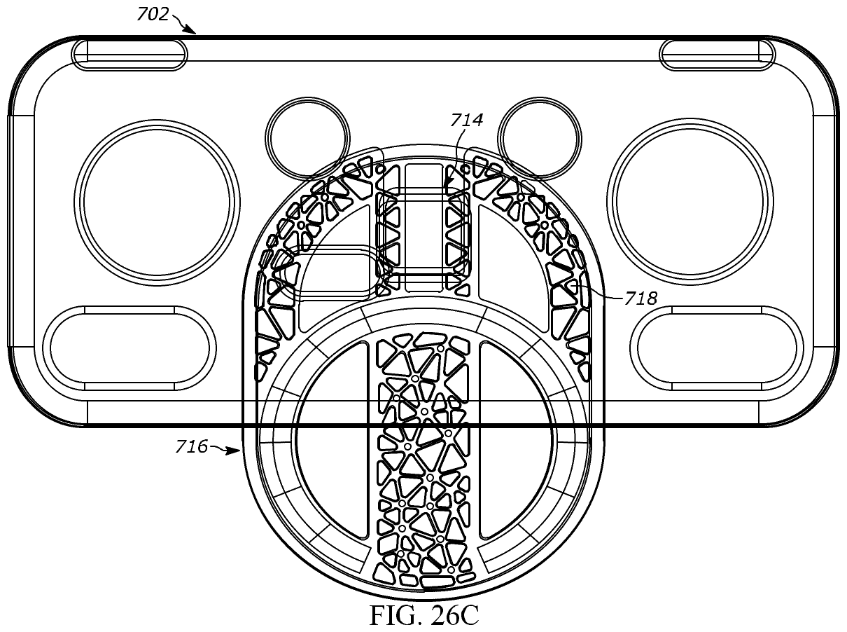

In particular embodiments, as illustrated in FIGS. 25, 26A, and 26B, the puck 700 is a compliant friction fit puck 716. The compliant friction fit puck 716 may be formed of a compliant material such as, but not limited to, foam, silicone, rubber, or another polymer to create a friction fit to the mobile electronic device 104 when it is mounted on the compliant friction fit puck 716. In one or more embodiments, the compliant friction fit puck 716 includes a pattern 718 that is formed through etching, printing, additive printing, or by other methods. The pattern 718 may serve as a non-skid surface to allow an attached mobile electronic device 104 to resist being unintentionally removed from the puck 700 and/or the attachable accessory 100.

In particular embodiments, as shown in FIGS. 26A, 26B, and 26C, the compliant friction fit puck 716 may comprise at least two parts or portions that are able to slide relative to each other to make the compliant friction fit puck 716 larger or smaller to accommodate different-sized mobile electronic devices 104. The compliant friction fit puck is mounted on the shoe 714 and upper-case surface 702 in such a way that it can be moved in both a lateral direction along an axis of the upper-case element 106 and/or the mobile electronic device 104, from a first position as shown in FIG. 26A to a second position as shown in FIG. 26B. The compliant friction fit puck 716 may be rotatable in an angular direction due to rotation occurring from the shoe 714. Alternatively, the compliant friction fit puck 716 may be removed and reinserted in a portrait orientation relative to the upper-case element 106 to achieve a portrait mounted orientation for the mobile-electronic device 104, such as shown in FIG. 26C.

Grips with Integrated Strap

In particular embodiments the attachable accessory 100 may be held by a user when being used to play games by wrapping a left forefinger around the back left edge of the attachable accessory 100 and wrapping a right forefinger around the back right edge of the controller, so that the user's forefingers and thumbs are positioned to be able to operate buttons, d-pad 330, and/or face buttons 332. This also enables the user to hold the game controller using his or her palms pressed against the sides of the attachable accessory 100, with thumbs operable to, for example, operate the left analog stick 328A and right analog stick 328B (joysticks) as shown, for example, in FIG. 3C. This form factor, as described above, enables the attachable accessory 100 and attached mobile electronic device 104 to easily fit into the user's pocket. However, some users, especially those with larger hands, might prefer to have actual handgrips to rest their hands on while operating the attachable accessory 100.

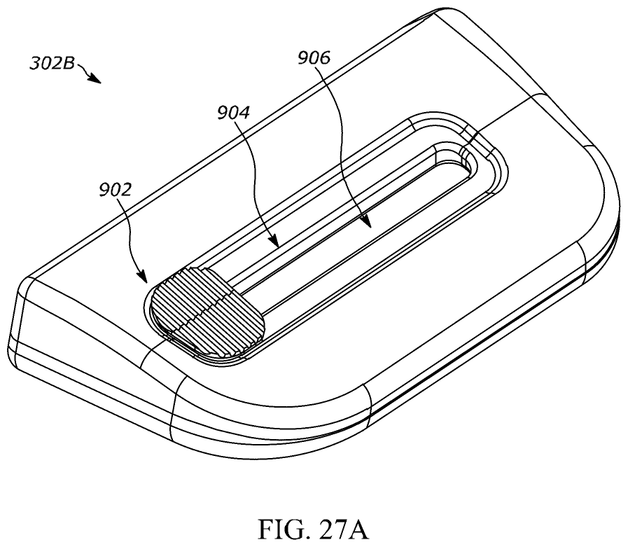

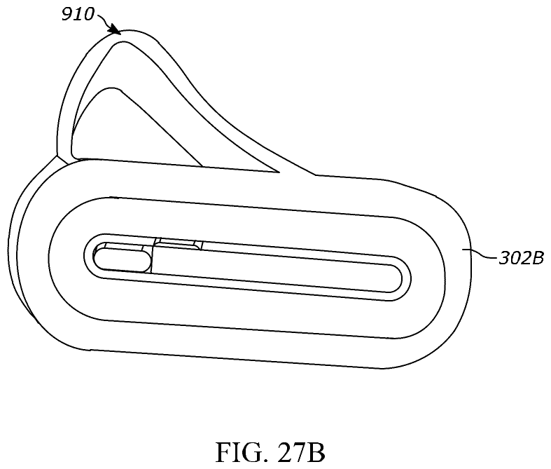

In particular embodiments, hand grips 302A and 302B are provided, which may fold from a first position that is inside the lower-case element 102 to a second position that is outside the lower-case element 102, as shown in FIG. 3C. The hand grips 302A and 302B may be magnetically attachable or detachable from the lower-case element 102 and/or provided as an accessory as seen in FIGS. 27A-30B. Similar to that of FIG. 3C, the grips in the particular embodiments shown in FIGS. 27A-30B include a lefthand grip 302A (not shown) and a righthand grip 302B.

In particular embodiments, the hand grips 302A and 302B may include embedded electronics 918, including processors, sensors, motors, and wireless transceivers. One or more of these embedded electronics 918 may be incorporated into a single integrated circuit (IC) or one or more may be separate components. These embedded electronics 918 allow the hand grips 302A and 302B to be able to communicate with an attached mobile electronic device 104 and/or other components or circuitry of the attachable accessory 100. The embedded electronics 918 also allow the grips to provide or augment the functionality of the attachable accessory 100, mobile electronic device 104, and/or applications hosted by the mobile electronic device 104 and/or attachable accessory 100.

In particular embodiments, the embedded electronics 918 may provide additional sensory input for augmenting and allowing for additional interaction with an application hosted by the mobile electronic device 104 and/or augmenting the attachable accessory 100 or application's functionality, including, but not limited to, temperature, motion, state-sensing, angle, touch, force, and power. As an example and not by way of limitation, the hand grips 302A and 302B may include gyroscopes for determining the orientation of the hand grips 302A and 302B, heat sensors such as thermocouples or other integrated circuit (IC) based temperature sensor for measuring a user's temperature and/or environmental temperatures, electrical sensor, and any other sensor that may be used for interacting with a user or obtaining physiological, environmental, or other useful information needed to supplement the functionality of an application or that of the attachable accessory 100. Furthermore, the hand grips 302A and 302B may contain sensors for determining angle relative to the lower-case element 102 and for state-sensing if they are in an open or closed position relative to the lower-case element 102.

In particular embodiments, the embedded electronics 918 may provide additional output for augmenting and/or enhancing the output from the mobile electronic device 104 and/or attachable accessory 100. As an example and not by way of limitation, the embedded electronics 918 may augment the output by providing additional functionality such as vibration, illumination, haptics, location, and audio. The hand grips 302A and 302B may include additional components such as speakers and lights, for example, in a non-limiting example, light emitting diode (LED) lights, for enhancing a user's experience when using the attachable accessory 100. The input sensors within the handle grips 302A and 302B, or sensors within the mobile electronic device 104 may be used to adjust the output of the embedded electronics 918. The embedded electronics 918 may take any suitable form, and the disclosure is not limited to those described above.

In particular embodiments shown in FIGS. 27A-30B, the one or more grips, such as righthand grip 302B, may include an integrated strap 910 for assisting a user in holding the grips 302B. As an example and not by way of limitation, the grip, e.g., 302B shown in FIGS. 27A-29 includes a slider 902 for deploying the integrated strap 910. While only one grip 302B is shown, both grips 302A and 302B of the attachable accessory 100 may include integrated straps 910. The integrated strap 910 may be movable between an extended position where a user may insert their hands, wrist, or one or more fingers to ensure that the grip 302B is secured to them. FIG. 27B illustrates an example embodiment of the integrated strap 910 in the extended positions. The integrated strap 910 may be extended or retracted into the grip 302B based on the position of the slider 902. Alternatively, the integrated strap 910 may be retracted in the grip 302B without the use of the slider 902 by folding it up along pivot points or by use of other mechanisms. In a third alternative, the integrated strap 910 may simply attach to the bottom of the grip 302B with no mechanism for retracting it being provided.

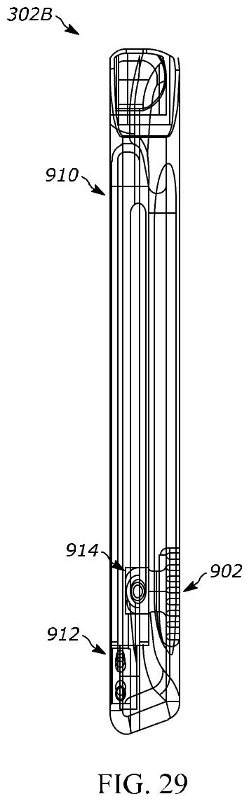

As shown in FIG. 27A and FIG. 29, the slider 902 may reside in an indentation 904 in the grip 302B. The slider 902 is shown as a grooved oval and may be made of a polymer, metal, or other appropriate material. The slider 902 may take any shape or configuration, including being smooth, textured, round, or rectangular. The slider 902 may move on a track 906 that is part of the indentation 904 and may include a part 914 disposed in the track 906, which causes the integrated strap 910 to either extend out of the grip 302B or retract within the grip 302B. Then, in use, a user would move the slider 902 out to extend the integrated strap 910.

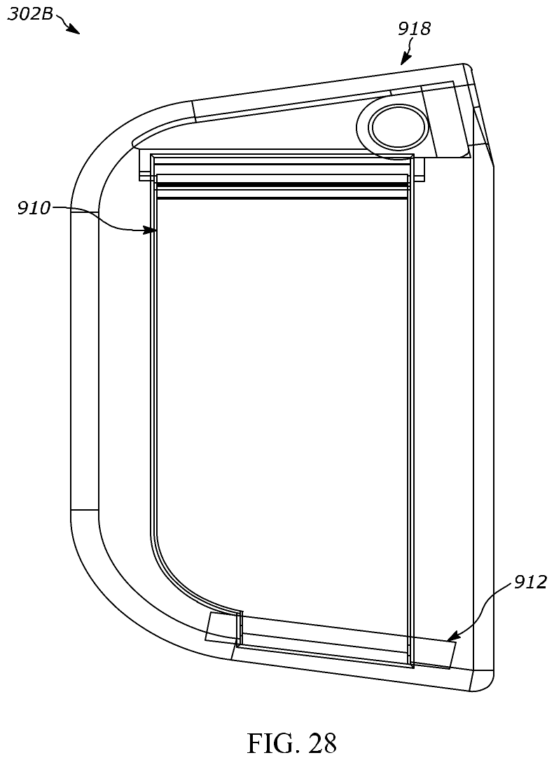

In particular embodiments as shown, for example, in FIG. 28, the integrated strap 910 may be attached by one or more fasteners 912 to removably connect the integrated strap 910 to a lower surface of the grip 302B and/or the lower-case element 102, such as by screws, fasteners, inserts, clamps, lock pins, springs, or other suitable connectors, providing flexibility for assembly, replacement, or customization. In a particular embodiment, the slider 902 may be configured with a spring or other mechanism to tension the integrated strap 910. When in use, a user would move the slider 902 out to extend the integrated strap 910.

In particular embodiments, the grips 302A and 302B may be slidably connected to the lower-case element 102 via rails, tracks, guides, and so forth. In particular embodiments, one or more retaining elements such as latches, clips, snap-fit elements, magnetic features, or other suitable components may be provided to releasably retain and/or hold the grips in the extended or captured position as needed, enhancing handling of the attachable accessory 100.

In particular embodiments, the grips 302A and 302B may be removably connected to the lower-case element 102 such as by screws, fasteners, inserts, clamps, lock pins, or other suitable connectors, providing flexibility for assembly, replacement, or customization. When the user extends the integrated strap 910 using the slider 902, the tension from the spring or other mechanism works to bring the integrated strap 910 back into the grip 302B. This allows the integrated strap 910 to apply pressure to the hand or fingers that have been inserted into the strap, allowing the user to more securely hold the grip 302B.

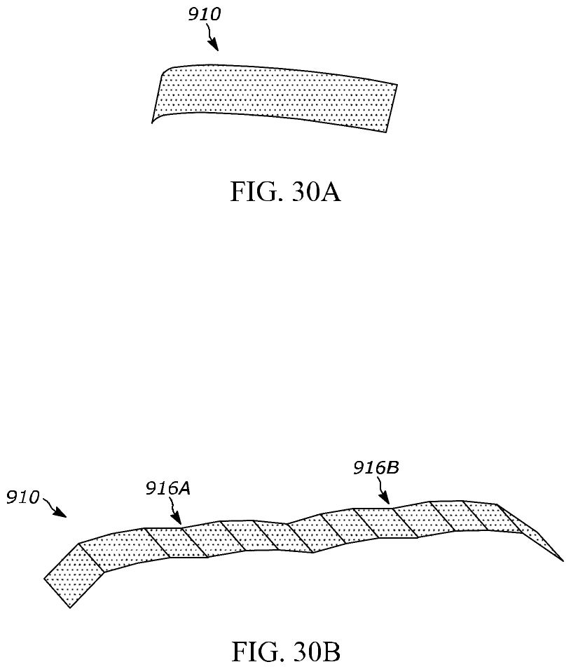

The integrated strap 910 may be made of any material and may take any form. As an example and not by way of limitation, the integrated strap 910 may be made of an elastic material, one or more flexible polymers, leather, cloth, or any other material that may be extended and retracted into the grip 302B. As shown in FIG. 30A, the integrated strap 910 may have a simple curved shape. Alternatively, in FIG. 30B, an alternative strap 910, may include one or more joints or pivot points 916A and 916B. These pivoting points, 916A and 916B, may be one or more hinges or one or more other types of joints. The integrated strap 910 may be pulled or rolled inside of the grip 302B, or the integrated strap 910 may be folded up using folding techniques such as those known from origami or other methods of folding, allowing the integrated strap 910 to be folded up in a more compact configuration when disposed of in the grip 302B.

### Recitation of Example Embodiments

Embodiment 1. An attachable accessory for mobile electronic devices comprising: an upper-case element configured to secure a mobile electronic device; a lower-case element with one or more input interfaces disposed on a top portion of the lower-case element, the one or more input interfaces allowing a user to interact with the mobile electronic device; and an opening mechanism configured to couple the upper-case element to the lower-case element, wherein: the opening mechanism enables the attachable accessory to move from a closed position to an expanded position; when the attachable accessory is in the closed position, the attachable accessory is in a compact configuration in which the upper-case element substantially overlays the lower-case element, and in which the top portion of the lower-case element is substantially covered by the upper-case element; when the attachable accessory is in the expanded position, the attachable accessory is in an expanded configuration in which the upper-case element is substantially displaced from the lower-case element and in which the top portion of the lower-case element is substantially exposed; and the opening mechanism comprises an actuator, wherein the actuator is operable to cause the upper-case element and lower-case element to move relative to each other between the closed position and the expanded position.
Embodiment 2. The attachable accessory of Embodiment 1, wherein the actuator comprises one or more springs that are operable to cause movement of the upper-case element from the closed position to the expanded position.
Embodiment 3. The attachable accessory of either of Embodiments 1-2, wherein the one or more springs comprise one or more of: one or more constant force springs; or one or more dampening springs.
Embodiment 4. The attachable accessory of any of one Embodiments 1-3, wherein the actuator is disposed in one or more of: the lower-case element; or the upper-case element.
Embodiment 5. The attachable accessory of any of one Embodiments 1-4, further comprising a slider which is pivotally attached to the upper-case element and receives a force from the actuator to move from a first position where the slider is substantially inside of the lower-case element to a second position where the slider is at least in part outside of the lower-case element.
Embodiment 6. The attachable accessory of any of one Embodiments 1-5, wherein the opening mechanism is further operable to cause the upper-case element to detach from the lower-case element, and wherein the slider is operable to be used as a standalone kickstand for the upper-case element when positioned on a surface.
Embodiment 7. The attachable accessory of any of one Embodiments 1-5, wherein the slider is curved to cause the upper-case element to move in a direction that is both away from and transverse to the lower-case element.
Embodiment 8. The attachable accessory of any of one Embodiments 1-7, wherein the actuator comprises a motor that is operable to cause movement of the upper-case element from the closed position to the expanded position, and from the expanded position to the closed position.
Embodiment 9. The attachable accessory of any of one Embodiments 1-8, wherein the motor is controllable by the mobile electronic device.
Embodiment 10. The attachable accessory of any of one Embodiments 1-8, wherein the motor is controllable by one or more interactive elements on the lower-case element.
Embodiment 11. The attachable accessory of any of one Embodiments 1-8, wherein the motor is a rack and pinion motor, and wherein the motor is operable to move a slider attached to the upper-case element.
Embodiment 12. The attachable accessory of any of one Embodiments 1-8, where the motor is operable to move a threaded rod attached to the upper-case element.
Embodiment 13. The attachable accessory of any of one Embodiments 1-12, wherein the one or more input interfaces are configured to interact with a digital application executing on the mobile electronic device.
Embodiment 14. The attachable accessory of any of one Embodiments 1-13, wherein the one or more input interfaces comprise a keyboard.
Embodiment 15. The attachable accessory of any of one Embodiments 1-14, wherein the one or more input interfaces comprise a gaming controller.
Embodiment 16. The attachable accessory of any of one Embodiments 1-15, wherein the one or more input interfaces comprise a digital display.
Embodiment 17. The attachable accessory of any of one Embodiments 1-16, wherein the one or more input interfaces comprise a touch pad.
Embodiment 18. The attachable accessory of any of one Embodiments 1-17, further comprising a first grip and a second grip, wherein the first grip and the second grip are movable from a first position that is inside of the lower-case element to a second position that is outside of the lower-case element.
Embodiment 19. A system comprising: a mobile electronic device; and an attachable accessory, wherein the attachable accessory comprises: an upper-case element configured to secure the mobile electronic device; a lower-case element with one or more input interfaces disposed on a top portion of the lower-case element, the one or more input interfaces allowing a user to interact with the mobile electronic device; and an opening mechanism configured to couple the upper-case element to the lower-case element, wherein: the opening mechanism enables the attachable accessory to move from a closed position to an expanded position; when the attachable accessory is in the closed position, the attachable accessory is in a compact configuration in which the upper-case element substantially overlays the lower-case element, and in which the top portion of the lower-case element is substantially covered by the upper-case element; when the attachable accessory is in the expanded position, the attachable accessory is in an expanded configuration in which the upper-case element is substantially displaced from the lower-case element and in which the top portion of the lower-case element is substantially exposed; and the opening mechanism comprises an actuator disposed in the lower-case element, wherein the actuator is operable to cause the upper-case element and lower-case element to move relative to each other between the closed position and the expanded position.
Embodiment 20. An attachable game controller comprising: an upper-case element configured to secure a mobile electronic device; a lower-case element with one or more gaming control elements disposed on a top portion of the lower-case element, the one or more gaming control elements allowing a user to interact with one or more gaming applications on the mobile electronic device; and an opening mechanism configured to couple the upper-case element to the lower-case element, wherein: the opening mechanism enables the attachable game controller to move from a closed position to an expanded position; when the attachable game controller is in the closed position, the attachable game controller is in a compact configuration in which the upper-case element substantially overlays the lower-case element, and in which the top portion of the lower-case element is substantially covered by the upper-case element; when the attachable game controller is in the expanded position, the attachable game controller is in an expanded configuration in which the upper-case element is substantially displaced from the lower-case element and in which the top portion of the lower-case element is substantially exposed; and the opening mechanism comprises an actuator disposed in the lower-case element, wherein the actuator is operable to cause the upper-case element and lower-case element to move relative to each other between the closed position and the expanded position.
Embodiment 21. An attachable accessory for mobile electronic devices comprising: an upper-case element configured to secure a mobile electronic device, wherein: the upper-case element comprises a puck that secures the mobile electronic device to the upper-case element; and the puck is connected to a top surface of the upper-case element in such a way that the puck is movable along a lateral axis from a first position to a second position parallel to the top surface of the upper-case element; a lower-case element with one or more input interfaces disposed on a top portion of the lower-case element, the one or more input interfaces allowing a user to interact with the mobile electronic device; and an opening mechanism configured to couple the upper-case element to the lower-case element, wherein the opening mechanism enables the attachable accessory to move from a closed position to an expanded position.
Embodiment 22. The attachable accessory of Embodiment 21, wherein the puck includes a first magnetic component configured to magnetically couple the puck to a second magnetic component in the mobile electronic device.
Embodiment 23. The attachable accessory of either of Embodiment 21-22, wherein the puck connects to the top surface of the upper-case element through a shoe.
Embodiment 24. The attachable accessory of any of one Embodiments 21-23, wherein the shoe is configured to wirelessly transfer data to or from the mobile electronic device.
Embodiment 25. The attachable accessory of any one of Embodiments 21-23, wherein the shoe is configured to wirelessly transfer electrical power to or from the mobile electronic device.
Embodiment 26. The attachable accessory of any one of Embodiments 21-25, wherein the puck is operable to move in a direction parallel to a first axis of the top surface of the upper-case element, and wherein the puck is further operable to move in a rotational direction relative to the first axis.
Embodiment 27. The attachable accessory of any one of Embodiments 21-26, wherein the puck is attached to the top surface of the upper-case element through a track that extends along the first axis and includes at least two curved portions that allow the puck to move in the rotational direction.
Embodiment 28. The attachable accessory of any one of Embodiments 21-26, wherein when the puck is moved in the rotational direction the mobile electronic device is moved from a portrait to a landscape orientation.
Embodiment 29. The attachable accessory of any one of Embodiments 21-28, wherein a top surface of the puck comprises a compliant material that is deformable to provide a friction fit when the mobile electronic device is placed on the top surface.
Embodiment 30. The attachable accessory of any one of Embodiments 21-29, wherein the puck comprises at least two parts that are able to slide relative to each other to make the puck larger or smaller.
Embodiment 31. The attachable accessory of any one of Embodiments 21-30, wherein a top surface of the puck comprises an etched pattern on at least one surface that is opposite the top surface of the upper-case element.
Embodiment 32. The attachable accessory of any one of Embodiments 21-31, wherein the etched pattern acts as a non-skid surface, to allow the mobile electronic device to resist being unintentionally removed from the attachable accessory.
Embodiment 33. The attachable accessory of any one of Embodiments 21-32, further comprising a first grip and a second grip, wherein the first grip and the second grip are movable from a first position that is inside of the lower-case element to a second position that is outside of the lower-case element.
Embodiment 34. The attachable accessory of any one of Embodiments 21-33, wherein the first grip and the second grip are configured to be detached from the lower-case element.
Embodiment 35. The attachable accessory of any one of Embodiments 21-33, wherein the first grip and the second grip each include a strap on a lower surface that is configured to secure a corresponding one of the first grip and the second grip to one or more of a finger, hand, or wrist of a user of the attachable accessory.
Embodiment 36. The attachable accessory of any one of Embodiments 21-35, wherein at least one of the first grip and the second grip includes embedded electronics configured to provide additional sensory input, including but not limited to temperature, motion, touch, force and power.
Embodiment 37. The attachable accessory of any one of Embodiments 21-36, wherein at least one of the first grip and the second grip includes embedded electronics configured to provide additional output, including but not limited to vibration, illumination, haptics, location and audio.
Embodiment 38. The attachable accessory of any one of Embodiments 21-37, wherein the one or more input interfaces are configured to interact with a digital application executing on the mobile electronic device.
Embodiment 39. The attachable accessory of any one of Embodiments 21-38, wherein the one or more input interfaces comprise a keyboard.
Embodiment 40. The attachable accessory of any one of Embodiments 21-39, wherein the one or more input interfaces comprise a gaming controller.
Embodiment 41. A system comprising: a mobile electronic device; and an attachable accessory, wherein the attachable accessory comprises: an upper-case element configured to secure the mobile electronic device wherein: the upper-case element comprises a puck that secures the mobile electronic device to the upper-case element; and the puck is connected to a top surface of the upper-case element in such a way that the puck is movable from a first position to a second position parallel to the top surface of the upper-case element; a lower-case element with one or more input interfaces disposed on a top portion of the lower-case element, the one or more input interfaces allowing a user to interact with the mobile electronic device; and an opening mechanism configured to couple the upper-case element to the lower-case element, wherein the opening mechanism enables the attachable accessory to move from a closed position to an expanded position.
Embodiment 42. An attachable game controller comprising: an upper-case element configured to secure a mobile electronic device, wherein: the upper-case element comprises a puck that secures the mobile electronic device to the upper-case element; and the puck is connected to a top surface of the upper-case element in such a way that the puck is movable from a first position to a second position parallel to the top surface of the upper-case element; a lower-case element with one or more gaming control elements disposed on a top portion of the lower-case element, the one or more gaming control elements allowing a user to interact with one or more gaming applications on the mobile electronic device; and an opening mechanism configured to couple the upper-case element to the lower-case element, wherein the opening mechanism enables the attachable game controller to move from a closed position to an expanded position.

### Miscellaneous

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, features, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

What is claimed is:

1. An attachable accessory for mobile electronic devices comprising:
an upper-case element configured to secure a mobile electronic device;
a lower-case element with one or more input interfaces disposed on a top portion of the lower-case element, the one or more input interfaces allowing a user to interact with the mobile electronic device; and
an opening mechanism configured to couple the upper-case element to the lower-case element, wherein:
the opening mechanism enables the attachable accessory to move from a closed position to an expanded position;
when the attachable accessory is in the closed position, the attachable accessory is in a compact configuration in which the upper-case element substantially overlays the lower-case element, and in which the top portion of the lower-case element is substantially covered by the upper-case element;
when the attachable accessory is in the expanded position, the attachable accessory is in an expanded configuration in which the upper-case element is substantially displaced from the lower-case element and in which the top portion of the lower-case element is substantially exposed; and
the opening mechanism comprises an actuator, wherein the actuator is operable to cause the upper-case element and lower-case element to move relative to each other between the closed position and the expanded position.

2. The attachable accessory of claim 1, wherein the actuator comprises one or more springs that are operable to cause movement of the upper-case element from the closed position to the expanded position.

3. The attachable accessory of claim 2, wherein the one or more springs comprise one or more of:
one or more constant force springs; or
one or more dampening springs.

4. The attachable accessory of claim 1, wherein the actuator is disposed in one or more of:
the lower-case element; or
the upper-case element.

5. The attachable accessory of claim 1, further comprising a slider which is pivotally attached to the upper-case element and receives a force from the actuator to move from a first position where the slider is substantially inside of the lower-case element to a second position where the slider is at least in part outside of the lower-case element.

6. The attachable accessory of claim 5, wherein the opening mechanism is further operable to cause the upper-case element to detach from the lower-case element, and wherein the slider is operable to be used as a standalone kickstand for the upper-case element when positioned on a surface.

7. The attachable accessory of claim 5, wherein the slider is curved to cause the upper-case element to move in a direction that is both away from and transverse to the lower-case element.

8. The attachable accessory of claim 1, wherein the actuator comprises a motor that is operable to cause movement of the upper-case element from the closed position to the expanded position, and from the expanded position to the closed position.

9. The attachable accessory of claim 8, wherein the motor is controllable by the mobile electronic device.

10. The attachable accessory of claim 8, wherein the motor is controllable by one or more interactive elements on the lower-case element.

11. The attachable accessory of claim 8, wherein the motor is a rack and pinion motor, and wherein the motor is operable to move a slider attached to the upper-case element.

12. The attachable accessory of claim 8, where the motor is operable to move a threaded rod attached to the upper-case element.

13. The attachable accessory of claim 1, wherein the one or more input interfaces are configured to interact with a digital application executing on the mobile electronic device.

14. The attachable accessory of claim 1, wherein the one or more input interfaces comprise a keyboard.

15. The attachable accessory of claim 1, wherein the one or more input interfaces comprise a gaming controller.

16. The attachable accessory of claim 1, wherein the one or more input interfaces comprise a digital display.

17. The attachable accessory of claim 1, wherein the one or more input interfaces comprise a touch pad.

18. The attachable accessory of claim 1, further comprising a first grip and a second grip, wherein the first grip and the second grip are movable from a first position that is inside of the lower-case element to a second position that is outside of the lower-case element.

19. A system comprising:
a mobile electronic device; and
an attachable accessory, wherein the attachable accessory comprises:
an upper-case element configured to secure the mobile electronic device;
a lower-case element with one or more input interfaces disposed on a top portion of the lower-case element, the one or more input interfaces allowing a user to interact with the mobile electronic device; and
an opening mechanism configured to couple the upper-case element to the lower-case element, wherein:
the opening mechanism enables the attachable accessory to move from a closed position to an expanded position;
when the attachable accessory is in the closed position, the attachable accessory is in a compact configuration in which the upper-case element substantially overlays the lower-case element, and in which the top portion of the lower-case element is substantially covered by the upper-case element;
when the attachable accessory is in the expanded position, the attachable accessory is in an expanded configuration in which the upper-case element is substantially displaced from the lower-case element and in which the top portion of the lower-case element is substantially exposed; and
the opening mechanism comprises an actuator disposed in the lower-case element, wherein the actuator is operable to cause the upper-case element and lower-case element to move relative to each other between the closed position and the expanded position.

20. An attachable game controller comprising:
an upper-case element configured to secure a mobile electronic device;
a lower-case element with one or more gaming control elements disposed on a top portion of the lower-case element, the one or more gaming control elements allowing a user to interact with one or more gaming applications on the mobile electronic device; and
an opening mechanism configured to couple the upper-case element to the lower-case element, wherein:
the opening mechanism enables the attachable game controller to move from a closed position to an expanded position;
when the attachable game controller is in the closed position, the attachable game controller is in a compact configuration in which the upper-case element substantially overlays the lower-case element, and in which the top portion of the lower-case element is substantially covered by the upper-case element;
when the attachable game controller is in the expanded position, the attachable game controller is in an expanded configuration in which the upper-case element is substantially displaced from the lower-case element and in which the top portion of the lower-case element is substantially exposed; and
the opening mechanism comprises an actuator disposed in the lower-case element, wherein the actuator is operable to cause the upper-case element and lower-case element to move relative to each other between the closed position and the expanded position.
